(19) United States
(12) Patent Application Publication
(10) Pub. No.: US 2003/0182279 A1
(43) Pub. Date: Sep. 25, 2003

(54) Progressive prefix input method for data entry

(76) Inventor: Kevin John Willows, Mississauga (CA)

Correspondence Address: Mr. Kevin Willows, 1188 Ostler Court, Mississauga, ON, L5C 3G6, CA

(21) Appl. No.: 10/100,562

(22) Filed: Mar. 19, 2002

(51) Int. Cl. G06F 7/00

(52) U.S. Cl. 707/4

(57) ABSTRACT

A new class of fundamental input method for computers provides comprehensive access to a collection of data strings through a process of successive approximation. A prefix fragment of a desired data entry is used to generate a properly formed progressive prefix presentation set from the collection. Members of the presentation set are longer than the prefix fragment from which they are derived. Presentation sets are recursively-generated based on selections from the sets themselves where all members of the collection containing the prefix fragment also have at least one member of the presentation set as a prefix fragment. The method thus limits the size of presentation sets to accommodate the display space while allowing comprehensive access to the collection through successive approximation. The input method may be enhanced with add-on acceleration techniques and using auxiliary input methods permits creation of data strings unique from the collection and for expanding the collection.

### CROSS-REFERENCE TO RELATED APPLICATIONS

not applicable

### FEDERALLY SPONSORED RESEARCH

not applicable

### COMPUTER PROGRAM LISTING APPENDIX

not applicable

### BACKGROUND

1. Field of Invention

This invention relates to the process of data entry on computers. More particularly it represents a new class of fundamental data input methods for computers.

2. Description of Prior Art

With the advent of the hand held computing devices and the impending introduction of tablet computers, the popularity of pen based computing is finding a niche in modern society. These devices typically include fundamental input methods, to permit data entry without the use of external hardware. Examples of these input methods include handwriting recognition, glyph, and ideographic recognition, as well as the use of gestures, on-screen virtual keyboards and speech recognition. Along with these fundamental input technologies a variety of acceleration technologies have been developed to reduce the workload for operators during data entry tasks. These tasks include word processing, email, scheduling etc., where the serial nature of pen input is both slow and requires significant manual precision. Therefore the wide spread adoption of this new pen centric form of computing is dependent upon finding a better way of performing data entry, as the current technologies have proven to be inadequate.

Of the fundamental input methods used in practice, including gestures, glyphs, ideographs, and script entry, all require a degree of operator training due to the inability of the available input methods to recognize poorly formed entries. Training may also entail learning novel glyph shapes and generally requires greater than normal attention to detail on the part of the operator to ensure properly formed entries. With speech recognition it may be necessary to train the software itself to better compensate for the operator. Virtual keyboards suffer from a need for a high degree of accuracy when the operator is making selections due to the generally small size of the key images. Further, all of these methods have no intrinsic acceleration capabilities.

There are a variety of acceleration paradigms available to the fundamental input methods. These acceleration technologies may be broken down into essentially three modes. Mechanical acceleration reduces in some manner the physical motions or accuracy required to enter a given data sequence. Encoding defines data inputs or combinations thereof to represent extended data strings. Prediction utilizes knowledge of prior input to select from a collection a list of candidate strings that are suggested to potentially complete the desired input.

The effectiveness of an input method can be expressed in terms of the mechanical requirements, the ease of learning, and the simplicity of the tasks required during data entry. Further factors include the number of tasks and amount of task switching required during data entry. Also the manner in which acceleration is integrated with the input method has a major impact on the operator's performance. Another issue is how distracting the input tasks are from the process of composition.

Input methods may be deployed in conjunction with an individual application program or on an application independent basis. Application independence in this context is the ability of the input method to operate with any application without any special adaptation of the application or the input method itself. Independent operation is also exemplified by the ability to operate with multiple applications substantially simultaneously. Use in an application dependent environment is exemplified by the use of customized display methods and selection methods. Dependant operation is also seen in the use of application specific dictionaries and restrictions on dictionary updating.

In the prior art these input and acceleration technologies have been practiced in a variety of combinations.

Typewriter acceleration was achieved by generating words when keys were pressed beyond normal limits. The potential gain from this was limited however since each key was associated with only one candidate word and memorization was required for key to word association.

Acceleration through chording is a technique used commonly with keyboards. Chording ascribes characters, character strings or other meaning such as vowel sounds or commands to key combinations. Also there are several variants of this in the prior art that utilize key sequences, where sequential key operations are assigned meaning. Temporal sequencing is a special case where the timing between key strikes is used to distinguish normal key strikes from key sequences. These methods are recall based and require extensive learning to associate key patterns with associated meanings. They also require an elevated degree of manual coordination.

In a further variation on key sequencing, an operator enters text based on rules for cross-referencing abbreviations to strings without the need for memorization. The complexity of the rules dictate the mental processing required to determine the abbreviation. This cross-referencing is also not a normal task during composition and thus interferes with the normal flow of composition.

Another combination is the reassignment of keys on a keyboard. In some cases frequency and linguistic studies are used with on-screen virtual keyboards to display key images in close proximity to a given display location. The scanning required for these methods has a major drawback in that the operator has no assurance that the desired key will be well placed or even present. In other cases new keys are added to the display to represent whole words, syllables, prefixes, suffixes or other word parts based upon context. Drawbacks being, the limited number of new keys possible and the memorization required cross-referencing the key to word association. A variation on this involves sequencing where words are assigned to keys proceeded by the space bar and suffixes following letters. When grammatical rules are used for word construction, the method is precluded from being comprehensive in generating text for languages with many irregular forms (like English). Also the rule processing tasks are not conducive to composition.

In still another mode, keys of an on-screen keyboard are logically subdivided to perform more than one function depending on the portion of the key actuated. This method is recall dependent, as one must memorize the meaning associated with different parts of the key and is equivalent to adding a number of unmarked keys to the keyboard. This also increases the requirement for mechanical accuracy.

There are two prediction systems that are commonly found in commercial implementations. Inline prediction and list based prediction.

Inline prediction provides input completion candidates visually concatenated to the operator input. The operator may then confirm the completion suggestion using an acceptance command. The cursor entry point is not changed during input so if the completion candidate does not match that desired, the operator simply continues entering data. The main drawback of this is that there is only one opportunity for acceleration. The completion candidate matches the desired entry or it does not, therefore the probability of a correct completion candidate is limited in most natural language situations. A further limitation of most string completion techniques is that error correction is asymmetric. Generally, correction will require a mental task switch to an editing operation along with multiple commands to remove the incorrect portion of the entry. Following all this editing the operator must switch back to composition and regenerate the word or incorrect part thereof.

List based prediction uses lists of completion candidates generated for a given input fragment. As the input fragment grows character by character the word list is updated with the appropriate completion candidates. There are a variety of list selection algorithms described in the prior art based on word frequency, context semantics, word length etc. List based completion has a number of drawbacks however. Again it provides assistance only once per completed string. It also requires the operator to constantly switch tasks between character entry and list scanning to see if any of the candidates match the target word. Further complicating this paradigm is the need to keep the list from obscuring the input fragment, which in display limited applications, can be difficult to implement. The use of short lists has been the norm to reduce this problem and increase the rate the operator can scan the candidate list. However this has the side effect of reducing the size of the presentation set and thus reducing the probability of the list containing the target word. List ordering has also had a number of implementations to make it easier to locate the target word in the list. These have generally been used to keep the most likely word to the front of the list with methods of weighting to reorder the list based on historic data inputs. These list ordering techniques have become more and more elaborate, involving prediction techniques to narrow the set of words presented by analyzing context features such as semantics, word length and variations on usage frequency such as Most Recently Used etc. However these orderings are highly algorithmic making anticipation by the operator difficult if the target word is not readily apparent. This results in the need to keep lists short since the lists must be scanned. Another enhancement is the use of string-based acceleration as opposed to word acceleration so that strings of characters, representative of words, phrases, commands etc are made available in the acceleration context thus broadening the field of application for the acceleration method. This only serves to complicate the problem of selecting and ordering the candidate lists. List based prediction also exhibits the same error asymmetry seen with inline completion.

With the prior art prediction technologies, suggestions that are similar to the desired input are of little value. If a completion suggestion that is similar to the desired input is selected, task switching is required to edit the result and no additional acceleration is available to the operator. Further, in some instances, suggestions may be made based solely upon the suffix fragment the user is adding to the edited fragment resulting in suggestions that have no relevance to the desired input. Therefore it can be seen that editing completion suggestions may result in process flow that is not conducive to composition and may also be confusing.

Prior art systems have a number of drawbacks. The need for mechanical precision as well as recall oriented behavior or rule oriented behavior that require operator training or distracting mental processes. Also evidenced is the need to switch mental tasks repeatedly. Further, the acceleration systems exhibit asymmetric behavior for error correction and provide no assistance in the process of composition.

Accordingly it is evident that there is need in the art for an input method that reduces the mechanical requirements of data entry. It should also have little or no learning requirements. It should employ processing tasks, such as recognition, that do not distract the operator from composition. For suitably simple patterns, such as text strings, recognition is an innate mental process requiring little or no conscious effort. Acceleration should be inherent to the input method design, to avoid task switching. It should also provide symmetric behavior for error correction, meaning that errors should be as easy to correct, as they are to make. An input method should aid the operator in the process of composition and it should be adaptable to various modes of operation and application.

### OBJECTS AND ADVANTAGES

It is an object of the invention to introduce a new fundamental input method.

It is also an object of the invention to reduce the mechanical accuracy required to perform data entry on pen-based computers.

Another object of the invention is to reduce learning requirements.

Another object of the invention is to employ pattern matching as the primary data entry task.

Another object of the invention is to provide inherent acceleration.

It is also an object of the invention to provide symmetric error correction.

It is also an object of the invention to aid in the process of composition.

It is also an object of the invention that it may be used together with other input methods or acceleration techniques to produce hybrids.

Further, it is an object of the invention that it may be deployed in an application independent basis or application dependent basis as required.

That the invention improves over the drawbacks of prior input methods and accomplishes the advantages described above will become apparent from the following detailed description of the exemplary embodiments and the appended drawings and claims.

### SUMMARY OF THE INVENTION

The present invention represents a new class of fundamental input methods for data entry on computers. A progressive prefix input method (PPIM) provides a uniform and progressive means of browsing to members in a comprehensive collection of data strings. Navigation through the entire collection is possible using organized sequences of properly formed progressive prefix presentation sets. A prefix fragment of a desired data entry is used to generate a properly formed progressive prefix presentation set from the collection. Members of the presentation set are longer than the prefix fragment from which they are derived. These presentation sets are recursively-generated based on selections from the sets themselves where all members of the collection containing the prefix fragment also have at least one member of the presentation set as a prefix fragment. The method thus limits the size of presentation sets to accommodate the display space while allowing comprehensive access to the collection through successive approximation. Acceleration is innate to the design of a PPIM. A PPIM used alone has the capacity to enter any data from amongst a distinct collection of data strings. A PPIM may also be used in concert with auxiliary input methods to produce a hybrid input method. These hybrids may then be capable of entering any arbitrary data as well as gaining the ability to expand the PPIM collection thereby enhancing its capacity for accelerated input. A PPIM may also be coupled with other acceleration technologies to further enhance the acceleration capabilities of the PPIM.

### BRIEF DESCRIPTION OF THE DRAWINGS

FIG. 1A is a progressive prefix input method browsing environment in accordance with an exemplary embodiment of the present invention.

FIG. 1B is diagram of a typical pen based computer that provides an operating platform in accordance with an exemplary embodiment of the present invention.

FIG. 1C illustrates the display layout of an auxiliary input method in accordance with an exemplary embodiment of the present invention.

FIG. 1D illustrates the display layout of the hybrid input method components in accordance with an exemplary embodiment of the present invention.

FIG. 2 is a diagram illustrating a progressive prefix input-fragment history storage and the mode history storage of a progressive prefix browsing system in accordance with an exemplary embodiment of the present invention.

FIG. 3 is a diagram illustrating an input-fragment storage of a progressive prefix browsing system in accordance with an exemplary embodiment of the present invention.

FIG. 4 is a diagram illustrating an excerpt from a lexicographic dictionary in accordance with an exemplary embodiment of the present invention.

FIG. 5 illustrates an excerpt from a progressive prefix dictionary in accordance with an exemplary embodiment of the present invention.

FIG. 6A is a diagram illustrating a storage used for a lexicographic dictionary in accordance with an exemplary embodiment of the present invention.

FIG. 6B is a diagram illustrating a storage used for a progressive prefix dictionary in accordance with an exemplary embodiment of the present invention.

FIG. 6C is a diagram illustrating a storage used for an alphabet in accordance with an exemplary embodiment of the present invention.

FIG. 7A is a diagram illustrating a storage for a high frequency table in accordance with an exemplary embodiment of the present invention.

FIG. 7B is a diagram illustrating a storage for a high frequency presentation set in accordance with an exemplary embodiment of the present invention.

FIG. 7C is a diagram illustrating a storage for a properly formed progressive prefix presentation set in accordance with an exemplary embodiment of the present invention.

FIG. 8 is a logic flow diagram illustrating a browse-session in accordance with an exemplary embodiment of the present invention.

FIG. 9 is a logic flow diagram illustrating the detailed operation of a backspace process of a progressive prefix input method in accordance with an exemplary embodiment of the present invention.

FIG. 10 is a logic flow diagram illustrating the detailed operation of a browse-back process of a progressive prefix input method in accordance with an exemplary embodiment of the present invention.

FIG. 11 is a logic flow diagram illustrating the detailed operation of a mode-update process of a progressive prefix input method in accordance with an exemplary embodiment of the present invention.

FIG. 12 is a logic flow diagram illustrating the detailed operation of a rotate-case process of a progressive prefix input method in accordance with an exemplary embodiment of the present invention.

FIG. 13 is a logic flow diagram illustrating the process of generating properly formed progressive prefix presentation sets to build a progressive prefix dictionary from a lexicographic dictionary in accordance with an exemplary embodiment of the present invention.

FIGS. 14A and 14B is a logic flow diagram illustrating detail of the recursive portion of the process of generating properly formed progressive prefix presentation sets in accordance with an exemplary embodiment of the present invention.

FIG. 15 is a logic flow diagram illustrating detail of the process of adding nodes to the progressive prefix dictionary in accordance with an exemplary embodiment of the present invention.

FIG. 16 is a logic flow diagram illustrating the operation of extracting a presentation set in accordance with an exemplary embodiment of the present invention.

FIG. 17 is a logic flow diagram illustrating the operation of extracting a properly formed progressive prefix presentation set from a progressive prefix dictionary in accordance with an exemplary embodiment of the present invention.

FIG. 18 is a logic flow diagram illustrating the operation of extracting a high frequency presentation set in accordance with an exemplary embodiment of the present invention.

FIG. 19 is a logic flow diagram illustrating the operation of extracting a non-prioritized lexicographic word list presentation set in accordance with an exemplary embodiment of the present invention.

FIGS. 20A-20E is a diagram illustrating an exemplary selection sequence to generate a data-string using an auxiliary input method and two levels of high frequency presentation sets along with a progressive prefix input method in accordance with an exemplary embodiment of the present invention.

FIGS. 21A-21D is a diagram illustrating an exemplary selection sequence to generate a data-string using an auxiliary input method and one high frequency presentation set along with a progressive prefix input method in accordance with an exemplary embodiment of the present invention.

FIGS. 22A-22F is a diagram illustrating an exemplary selection sequence to generate a data-string using a stand-alone progressive prefix input method in accordance with an exemplary embodiment of the present invention.

FIG. 23 is a diagram illustrating a component embodiment of a progressive prefix input method in accordance with an exemplary embodiment of the present invention.

### DETAILED DESCRIPTION

The following descriptions of exemplary embodiments have numerous specific details set forth in order to provide a thorough understanding of the present invention. It will be obvious to those skilled in the art that the invention may be practiced without these specific details.

Definitions

There are named, invention specific data structures and processes used in the following description that are defined as follows.

a) An alphabet is a collection of mutually unique data units that, in combination, form larger semantic units. These data units will be referred to as characters. It should be noted that in this context the word character has a broader definition than in general use.

b) A data-string is any combination of characters forming a semantic unit or prefix-fragment thereof. A prefix-fragment (PF) being the first N characters of a data-string where N represents any number up to and possibly including the length of the data-string. A prefix-fragment may or may not have semantic significance.

c) An input-fragment is the accumulated operator input at any point in time representing a completed or partially completed data-string.

d) A dictionary is a collection of data-strings.

e) A progressive prefix class (PPC) is a collection of all dictionary members or prefix-fragments thereof where the collection members have a common prefix-fragment. This common PF is termed a class fragment (CF) for the PPC.

f) A null prefix-fragment (NPF) is a prefix-fragment that contains no data.

g) A global PPC (GPPC) encompasses a dictionary in its entirety. The NPF is the class-fragment for the GPPC.

h) A presentation set is a collection of dictionary members or prefix-fragments thereof, who's number and extent do not substantially exceed the confines of a given display space when displayed together.

i) A properly formed progressive prefix presentation set(s) (PFPS) is defined for a class-fragment and is defined as a collection of PPC members wherein: The collection members are longer than the class fragment itself, the collection meets the definition of a presentation set and all members of the PPC have at least one member of the collection as a prefix-fragment. Prefix-fragments common to a subset of PPC members may be added to the collection to subdivide the PPC. PFPS presentations are thus assured to fit within the display space and PFPS subdivision of the PPC assures comprehensive access to the entire PPC through recursive generation of PFPS based on selections therefrom. Hereafter PFPS members are referred to as prefix-fragments.

j) A progressive prefix input method (PPIM) employs PFPS to produce an input-fragment from a dictionary.

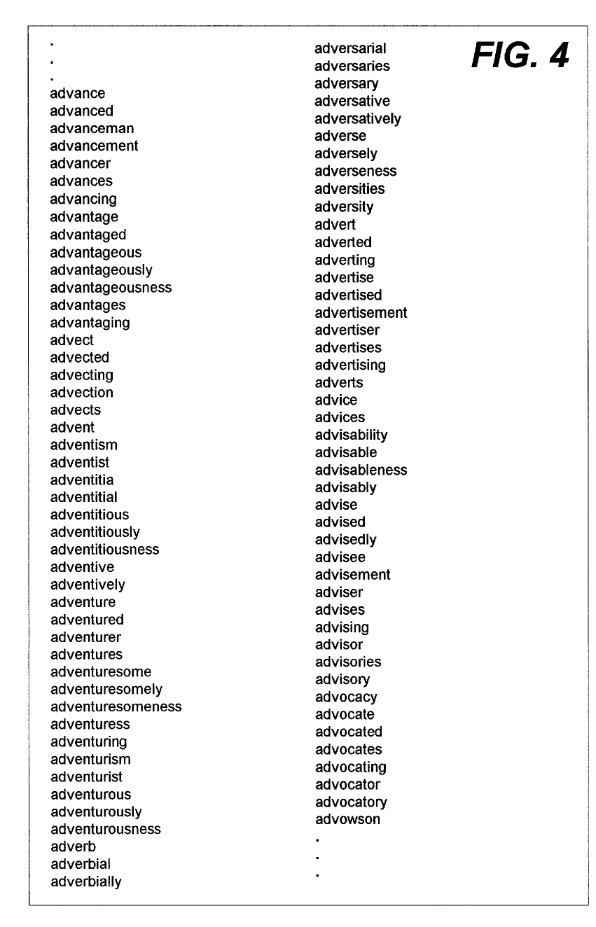

k) A lexicographic dictionary (LD) is a distinguished collection where the strings are ordered by their lexicographic structure. The dictionary fragment of FIG. 4 exemplifies this LD structure.

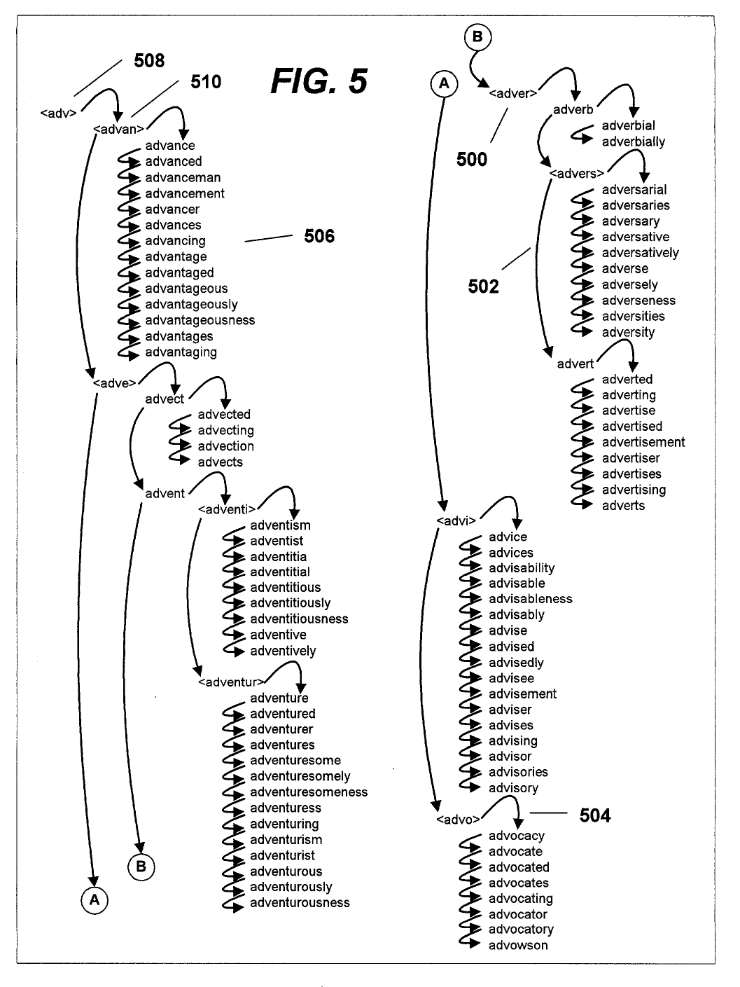

l) A progressive prefix dictionary (PPD) is a distinguished collection where the strings are structured into properly formed progressive prefix presentation sets. The progressive prefix dictionary fragment of FIG. 5 exemplifies this PPD structure.

m) A root-set (RS) is the PFPS formed from the NPF. The RS is the initial PFPS for all stand-alone implementations of a PPIM through which the GPPC may be accessed.

n) A high frequency presentation set(s) (HFPS) consists of high frequency dictionary members where all members have a common prefix-fragment.

o) An auxiliary input method (AIM) is an input method of any type used to permit the entry of data-strings that are unique from the contents of a dictionary.

p) A gesture is defined as stylus contact with a touch sensitive display screen followed by an extended sliding motion in a defined direction followed by lifting of the stylus. Meaning is ascribed to the gesture based on the direction of the motion.

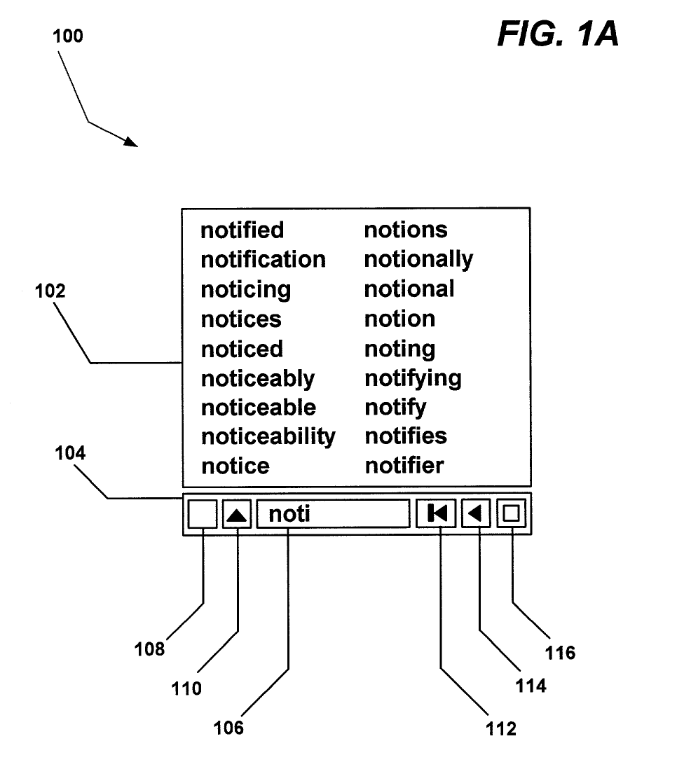

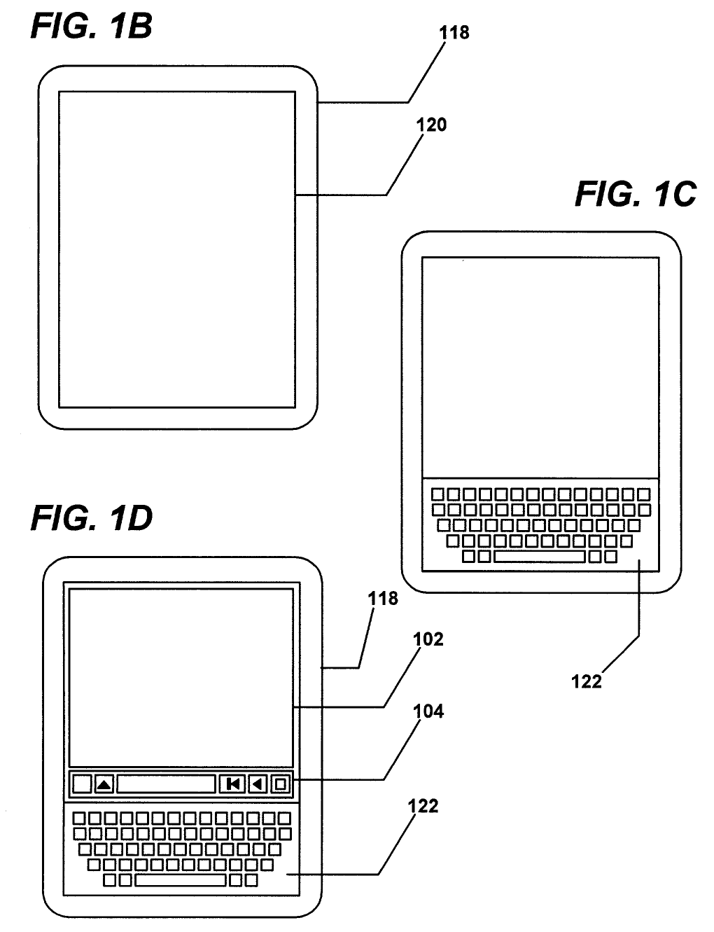

Detailed Description—Preferred Embodiment—FIGS. 1A-1D, 2, 3

FIG. 1A depicts a detailed view of a progressive prefix input method (PPIM) 100 with a browse-window 102, used to display a PFPS or HFPS. It also shows a command-bar 104 containing six elements, a mode button 108, a shift button 110, an input-display 106, a browse-back button 112, a backspace button 114, and a cancel button 116. FIG. 1B shows an exemplary operating environment of the PPIM 100 that includes a portable computer 118, containing a pressure sensitive flat screen display 120. FIG. 1C depicts the screen placement of an auxiliary input method 122 employed by the preferred embodiment. FIG. 1D depicts the computer 118 displaying all the components of the preferred embodiment that includes the browse-window 102, command-bar 104 and the auxiliary input method 122.

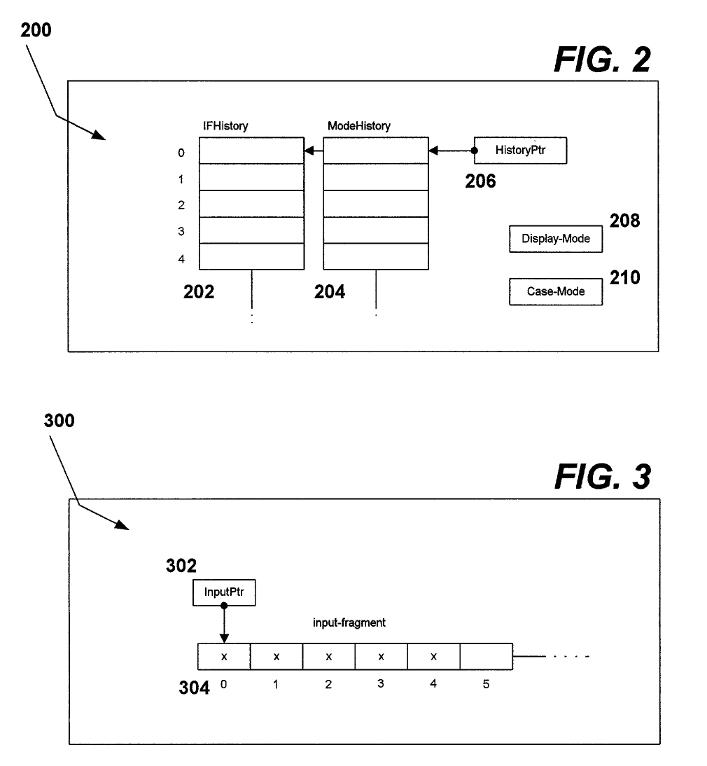

FIG. 2 illustrates a browser history storage 200, where two parallel arrays are used. During a browse-session 800 described below, an IFHistory array 202 holds the changes to an input-fragment 300 also described below. A ModeHistory array 204 holds a copy of a Display-Mode (DM) 208 for each prefix-fragment in the IFHistory 202. A HistoryPtr 206, is a pointer into the arrays 202, 204, indicating the element that will be filled on the next update of the input-fragment 300. In the preferred embodiment the HistoryPtr 206 is always pointing to an empty array entry. Thus when a browse-session 800 is started, the initialized input-fragment 300 is stored in the zero IFHistory array element and the initialized DM 208 is stored in the zero ModeHistory array element and the HistoryPtr 206 is set to one. A Case-Mode 210 storage maintains the text case for the input-fragment 300. Those skilled in the art will appreciate that there are numerous ways of implementing the browse history 200.

FIG. 3 illustrates an input-fragment 300 storage. The input-fragment 300 as entered by the operator is stored in sequential array elements of the input-fragment array 304. An InputPtr 302 may be used to indicate the array element that will receive the next character as entered by the operator. When a browse-session 800 is started the zero element of the fragment 304 receives the character entered by the operator and the InputPtr 302 is set to one. Subsequent character entries are stored in the fragment array 304 element pointed to by the inputPtr 302 which is then incremented. When selections are made from the browse-window 102, they replace the contents of the input-fragment 300 and the InputPtr 302 is made to point to the array 304 element that is one past the last character in the updated fragment 300. Those skilled in the art will appreciate that there are numerous ways of implementing the input-fragment 300.

Storage Implementation—FIGS. 4, 5, 6A-6C, 7A-7C

The dictionary used in the preferred embodiment is a progressive prefix dictionary (PPD) that has been generated from a lexicographic dictionary (LD). The following discussion details the storages used in implementing this PPD and LD as well as a high frequency table storage used for generating HFPS. Those skilled in the art will appreciate that the PPD may be preprocessed or partially preprocessed into progressive prefix form or PFPS creation may be done in real time during presentation set generation. The dictionary storages may also be implemented using a variety of data structures, for example tries etc. It should be noted that there is no unique heuristic for generating PFPS, so the dictionary of the preferred embodiment is only intended as an exemplary implementation.

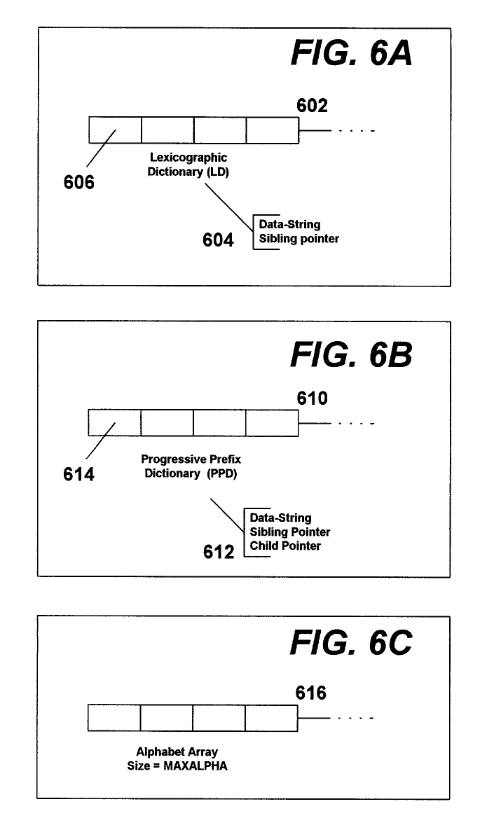

FIG. 4 illustrates an excerpt of a lexicographic dictionary. FIG. 6A illustrates how the LD storage may be implemented as a linked list of nodes 604, with each node 604 containing a data-string and a link to the next sibling node in lexicographic order.

FIG. 5 illustrates an excerpt of a progressive prefix dictionary (PPD) derived from the dictionary excerpt of FIG. 4. New nodes 500 that are not members of the LD and are indicated in angle brackets. New nodes 500 are inserted into the PPD when required as a means of subdividing the dictionary into PFPS. Arrows connecting the left edge of nodes represent a sibling relationship 502, and arrows connecting the right edges of nodes represent child relationships 504. In the preferred embodiment, all members of the PPC for a class-fragment are descendant nodes of the node representing the class-fragment. Also all nodes represent the longest common prefix-fragment (LCP) for their descendant nodes. For example, the <adv> node 508 represents the LCP for the entire dictionary excerpt. Those skilled in the art will appreciate that the added nodes 500 may be derived using a variety of heuristics other than the LCP heuristic used here. PFPS extraction is simplified by this structure since the PFPS for any given node is comprised of that node's child-node and all the child-node's siblings. For example the PFPS for the <advan> node 510 is the set of fourteen nodes 506 from advance through advantaging.

FIGS. 6A-6C illustrate storages that may be used in the creation of a progressive prefix dictionary as described for FIG. 5. FIG. 6A illustrates a storage organization for the lexicographic dictionary as described in FIG. 4. FIG. 6A illustrates the LD organized as a linked list 602 of nodes 604 where each node 604 contains a data-string and a link to the next sibling-node in the list. There is a unique root-node 606 that contains the first node in the list. FIG. 6B illustrates a storage organization for the progressive prefix dictionary as described in FIG. 5. FIG. 6B illustrates the PPD organized as a linked list 610 of nodes 612 where each node 612 contains a data-string, a link to the next sibling-node in the list, and a link to its first child-node. There is a unique root-node 614 that contains the first node in the PPD. FIG. 6C illustrates an alphabet array 616 containing all the characters of the alphabet for the dictionary, where the number of members is given by MAXALPHA that is implementation dependant.

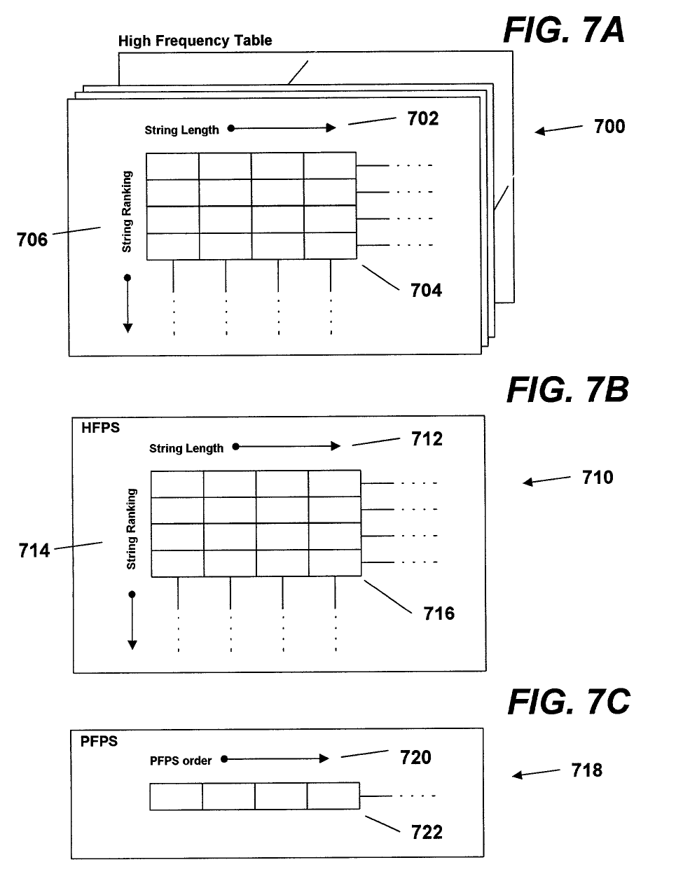

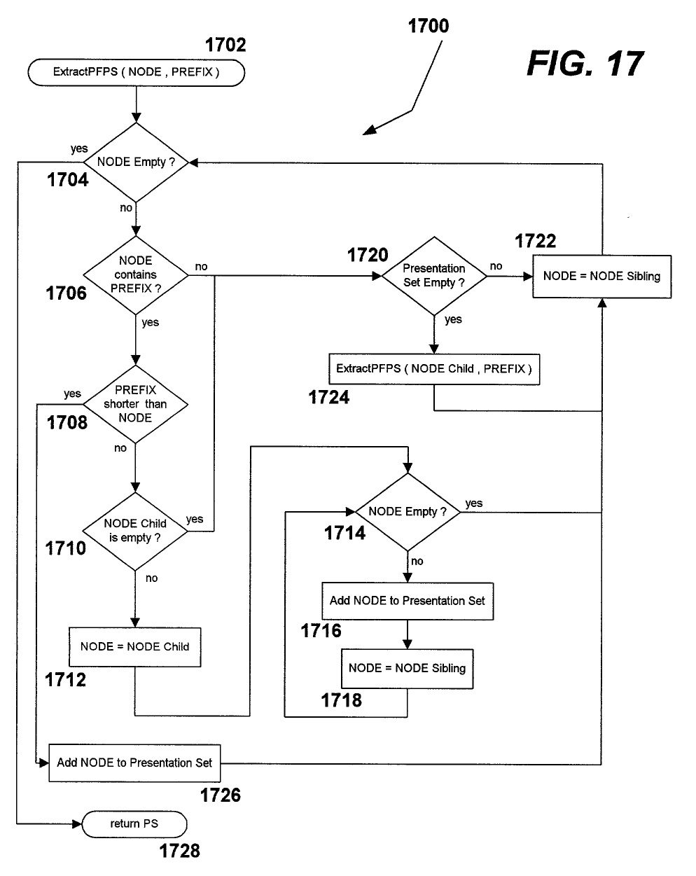

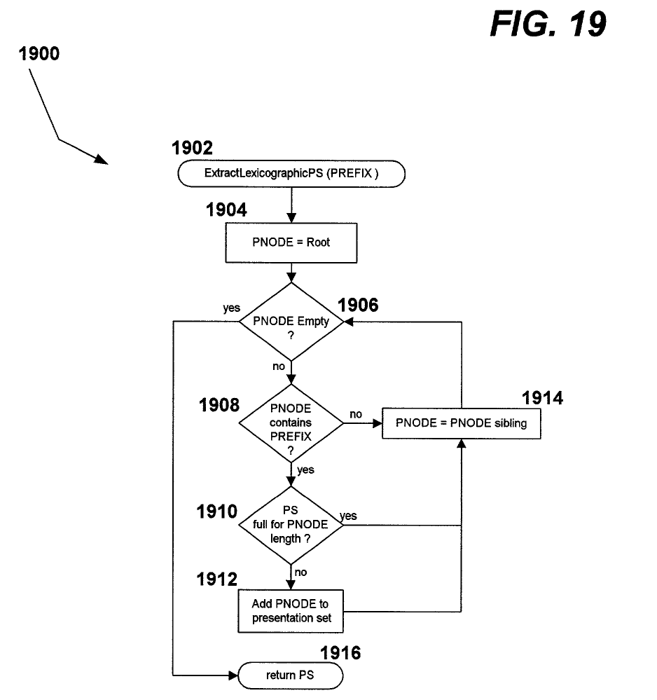

FIGS. 7A-7C illustrate storages that may be used to implement a high frequency table 700, along with HFPS 710 and PFPS 718 of the preferred embodiment. FIG. 7A depicts a three-dimensional table 700 of pointers to high frequency PPD members. This table 700 is organized into pages 704 with rows 702 ordered by string length and columns 706 ordered by string frequency. The pages 704 are organized by prefix-fragment, where each page 704 contains only dictionary members that are also members of the PPC for the prefix-fragment. Depending upon storage limitations of the implementation the table 700 may be made arbitrarily large. The preferred embodiment assumes the existence of pages 704 for all prefix-fragments shorter than 3 characters. FIG. 7B illustrates a storage organization for high frequency presentation sets 710. This storage 710 is a two-dimensional array 716 of pointers to dictionary members that represents a single page 704 from a high frequency table. If a high frequency table page 704 is not available for a given prefix-fragment, a lexicographic presentation set may be created as described in FIG. 19. In this case the dictionary is searched for members matching a prefix-fragment where columns 712 of the HFPS are filled as matches are found in lexicographic order. When the DM 208 is PPM, a one-dimensional array 722 as in FIG. 7C may be used to implement progressive prefix presentation-sets 718 for the preferred embodiment. In this case the array is filled in PFPS order 720 as described below for the process of FIG. 17.

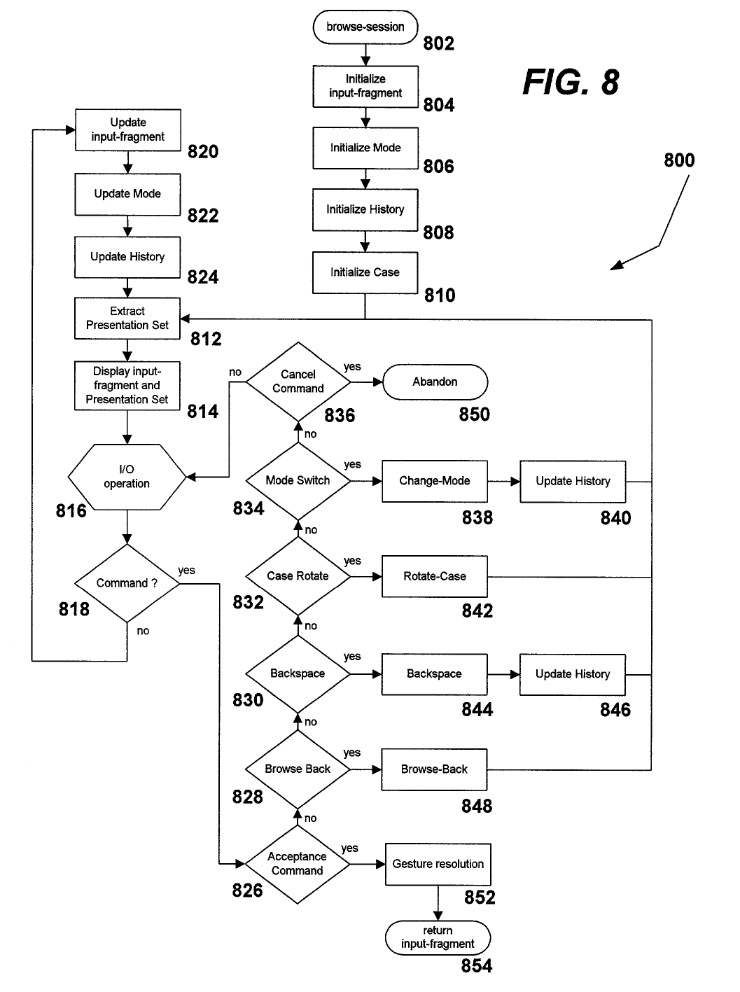

PPIM Browse Session—FIG. 8

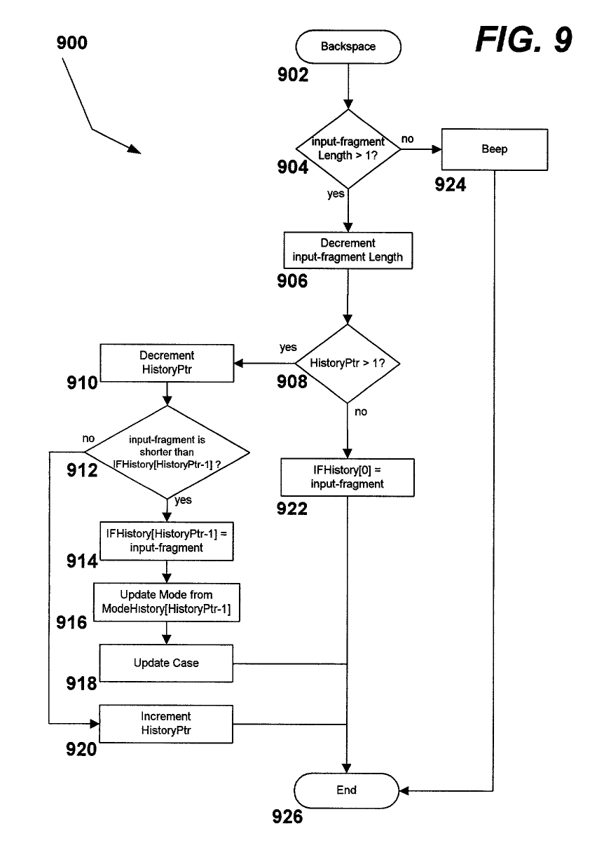

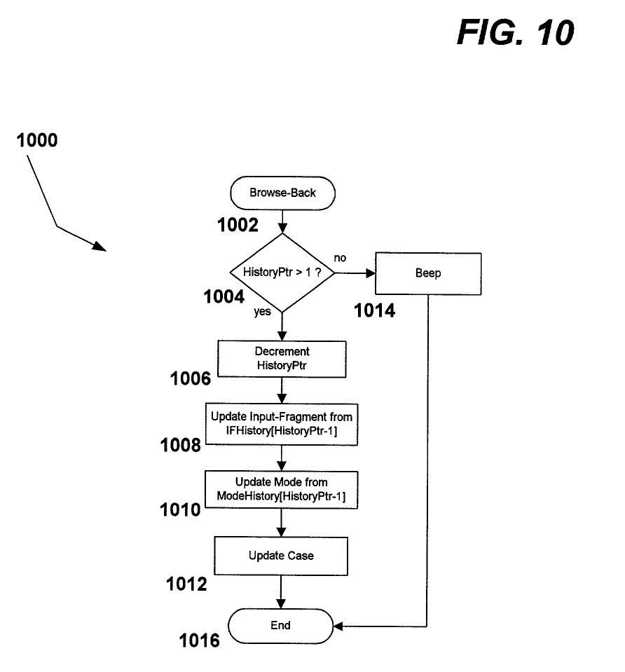

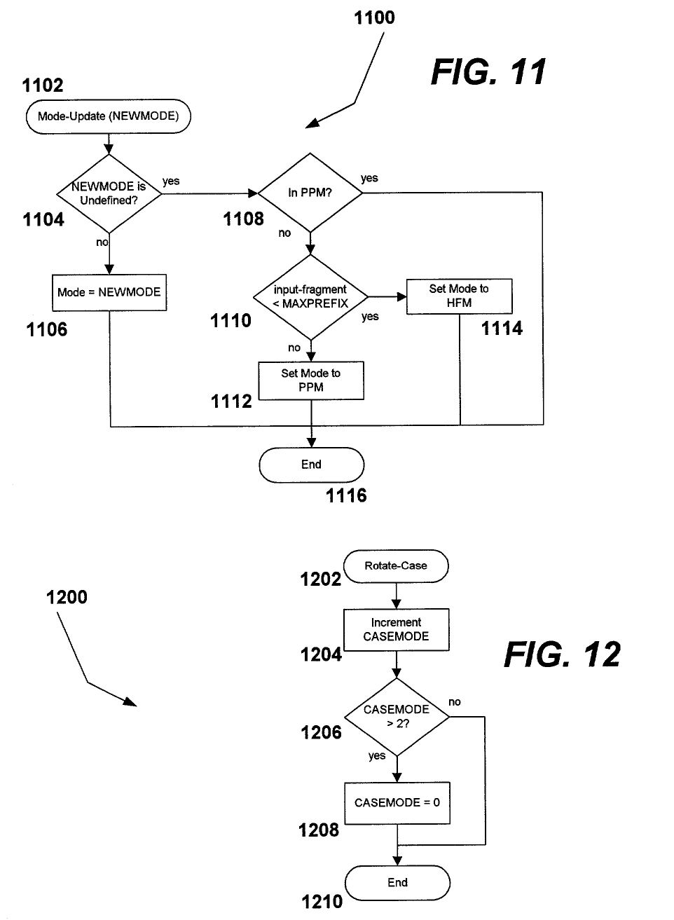

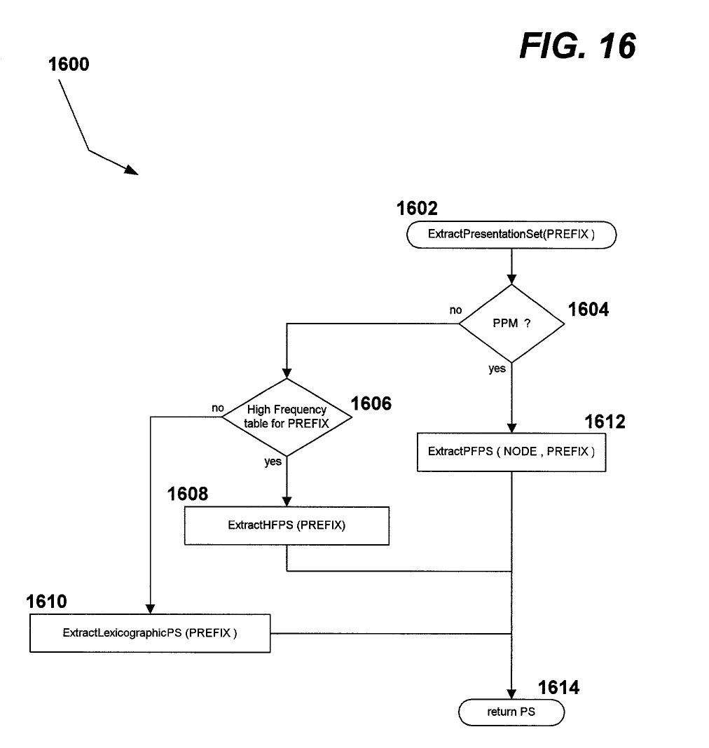

FIG. 8 illustrates a logic flow that may be used to implement the PPIM 100. Initially the PPIM 100 executes in the background monitoring the auxiliary input method (AIM) 122 while the browse-window 102 and command-bar 104 are not displayed. A browse-session 800 is initiated at step 802 when the PPIM 100 detects a character from the AIM 122. Step 802 is followed by step 804 where the input-fragment 300 is initialized to contain only the character entered by the operator. Step 804 is followed by step 806, in which the Display-Mode (DM) 208 is initialized to HFM. Step 806 is followed by step 808, in which the history 200 is initialized with the input-fragment 300 and DM 208. Step 808 is followed by step 810, in which the Case-Mode 210 is initialized and the text case of the input-fragment 300 is set accordingly. Step 810 is followed by step 812, where a presentation set is generated. Step 812 is explained in detail below in reference to FIG. 16. Step 812 is followed by step 814 where the input-fragment 300 is displayed 106 on the command-bar 104 and the presentation set generated in step 812 is displayed in the browse-window 102. Step 814 is followed by step 816 where the PPIM 100 waits for further input from the operator. When input is received, step 816 is followed by step 818. In step 818, if the operator input does not represent a command the “no” branch is taken to step 820, where the input-fragment 300 is updated based on the operator input in the following manner. Characters entered from the AIM 122 are concatenated to the input-fragment 300 while selections from the browse-window 102 replace the current input-fragment 300. Step 820 is followed by step 822, where the display mode is updated. Step 822 is explained in detail below in reference to FIG. 11. Step 822 is followed by step 824, where the history 200 is updated with the new input-fragment 300 and DM 208. Step 824 loops back to step 812, where a new presentation set is generated using the updated input-fragment 300. Referring back to step 818, if a command is encountered the “yes” branch is taken to step 826. In step 826, if the command is an acceptance command the “yes” branch is taken to step 852. In step 852, if a gesture has been used to select a browse-window 102 entry, any punctuation ascribed to the gesture is resolved here and concatenated to the input-fragment 300. Step 852 is followed by step 854, where the browse-session 800 is terminated and the input-fragment 300 is passed on as completed input to the active application. On termination the browse-window 102 and command-bar 104 are removed from the display 120 and the PPIM 100 proceeds back to monitoring the AIM 122 for character input. Referring back to step 826, if an acceptance command is not encountered the “no” branch is taken to step 828. In step 828, if a browse-back command is received the “yes” branch is taken to step 848. Step 848 restores the input-fragment 300 to the state just prior to the current state as explained in detail below with reference to FIG. 10. Step 848 loops back to step 812, where a new presentation set is generated using the updated input-fragment 300. Referring back to step 828, if a browse-back command is not encountered the “no” branch is taken to step 830. In step 830, if a backspace command is encountered the “yes” branch is taken to step 844. Step 844 truncates the last character from the input-fragment 300 as explained in detail below with reference to FIG. 9. Step 844 is followed by step 846 where the history 200 is updated to reflect any changes to the input-fragment 300. Step 846 loops back to step 812, where a new presentation set is generated using the updated input-fragment 300. Referring back to step 830, if a backspace command is not encountered the “no” branch is taken to step 832. In step 832, if a case-rotate command is received the “yes” branch is taken to step 842. Step 842 changes the text case of the input-fragment 300 as explained in detail below with reference to FIG. 12. Step 842 loops back to step 812, where a new presentation set is generated using the updated input-fragment 300. Referring back to step 832, if a case-rotate command is not encountered the “no” branch is taken to step 834. In step 834, if a mode-switch command is received the “yes” branch is taken to step 838. In step 838, if the DM 208 is HFM, it is changed to PPM, if the DM 208 is PPM, it is changed to HFM. Step 838 is followed by step 840, where the history 200 is updated to reflect the changes to the DM 208. Step 840 loops back to step 812, where a new presentation set is generated using the updated input-fragment 300. Referring back to step 834, if a mode-switch command is not encountered the “no” branch is taken to step 836. In step 836, if a cancel command is received the “yes” branch is taken to step 850. In step 850, the browse-session 800 is abandoned along with the input-fragment 300 and the browse-window 102 and command-bar 104 are removed from the display 120. On termination the PPIM 100 returns to monitoring the AIM 122 for character input. Referring back to step 836, if a cancel command is not encountered, the “no” branch loops back to step 816 to wait for further input from the operator.

Control Command Processes—FIGS. 9, 10, 11, 12

FIG. 9 illustrates a logic flow for a backspace process 900. The process 900 begins at step 902. Step 902 is followed by step 904, where if the input-fragment 300 is shorter than two characters the “no” branch is taken to step 924. In step 924 an audible tone is given to the operator to indicate that no more backspacing is possible. Step 924 is followed by step 926, where the process 900 ends and the encapsulating logic continues. Referring back to step 904, if the input-fragment 300 is longer than one character the “yes” branch is taken to step 906. In step 906 the InputPtr 302 is reduced by one, truncating the input-fragment 300 which is defined in detail with reference to FIG. 3. Step 906 is followed by step 908, where if HistoryPtr 206 is not greater than one the “no” branch is taken to step 922. In step 922 the IFHistory 202 is updated with the truncated input-fragment 300. Step 922 is followed by step 926. In step 926 the Backspace process 900 ends and the encapsulating logic continues. Referring back to step 908, if HistoryPtr 206 is greater than one, the “yes” branch is taken to step 910. In step 910 the HistoryPtr 206 is decremented. Step 910 is followed by step 912, where if the input-fragment 300 is shorter than the previous input-fragment in the IFHistory array 202 the “yes” branch is taken to step 914. In step 914 the IFHistory 202 is updated with the truncated input-fragment 300. Step 914 is followed by step 916, where the display-mode 208 is updated from the ModeHistory 204. Step 916 is followed by step 918 where the text case of the input-fragment 300 is updated based on the state of Case-Mode 210. Step 918 is followed by step 926, where the backspace process 900 ends and the encapsulating logic continues. Referring back to step 912, if the input-fragment 300 is not shorter than the previous input-fragment in the IFHistory array 202 the “no” branch is taken to step 920. In step 920 the HistoryPtr 206 is incremented leaving the history 200 unchanged. Step 920 is followed by step 926, where the backspace process 900 ends and the encapsulating logic continues.

FIG. 10 illustrates a logic flow for a browse-back process 1000. The process 1000 begins at step 1002. Step 1002 is followed by step 1004, where if the HistoryPtr 206 is less than two the “no” branch is taken to step 1014. In step 1014 an audible tone is given to the operator to indicate that the end of the history 200 has been reached. Step 1014 is followed by step 1016, where the process 1000 ends and the encapsulating logic continues. Referring back to step 1004, if the HistoryPtr 206 is greater than one the “yes” branch is taken to step 1006. In step 1006 the HistoryPtr 206 is decremented by one. Step 1006 is followed by step 1008, where the input-fragment 300 is updated from the IFHistory array 202 with the state previous to the current state. Step 1008 is followed by step 1010, where the DM 208 is updated from the ModeHistory array 204 with the mode previous to the current Display-Mode 208. Step 1010 is followed by step 1012, where the text case of the input-fragment 300 is updated based on the current state of Case-Mode 210. Step 1012 is followed by step 1016, where the process 1000 ends and the encapsulating logic continues.

FIG. 11 illustrates a logic flow for a Mode-Update process 1100. The process 1100 begins at step 1102, where a display mode, NEWMODE, is passed to the process. Step 1102 is followed by step 1104, where if NEWMODE is defined the “no” branch is taken to step 1106. Step 1106 sets the DM 208 to NEWMODE. Step 1106 is followed by step 1116, where the process 1100 ends and the encapsulating logic continues. Referring back to step 1104, if NEWMODE is undefined the “yes” branch is taken to step 1108. In step 1108, if the DM 208 is currently PPM the “yes” branch is taken to step 1116, where the process 1100 ends and the encapsulating logic continues. If the DM 208 is currently HFM the “no” branch is taken to step 1110, where if the input-fragment 300 is shorter than what may be an implementer defined constant MAXPREFIX, the “yes” branch is taken to step 1114. In step 1114, the DM 208 is set to HFM. Step 1114 is followed by step 1116, where the process 1100 ends and the encapsulating logic continues. Referring back to step 1110, if the input-fragment 300 is not shorter than MAXPREFIX, the “no” branch is taken to step 1112. In step 1112, the DM 208 is set to PPM. Step 1112 is followed by step 1116, where the process 1100 ends and the encapsulating logic continues. Thus if the DM 208 is initially in an undefined state, calling Mode-Update 1100 will set the DM 208 based on the length of input-fragment 300. The Mode-Update process 1100 may be manually invoked through activation of the Mode-Switch button 108. The Mode-Update process 1100 is generally invoked whenever the input-fragment 300 is changed to update the DM 208 based on the length of the input-fragment 300. Those skilled in the art will appreciate that there are numerous ways of implementing display mode updating.

FIG. 12 illustrates a logic flow for a Rotate-Case process 1200. The process 1200 begins at step 1202. Step 1202 is followed by step 1204, where Case-Mode 210 is increased by one. Step 1204 is followed by step 1206, where if Case-Mode 210 is less than three the “no” branch is taken to step 1210, where the process 1200 ends and the encapsulating logic continues. If Case-Mode 210 is greater than two the “yes” branch is taken to step 1208, where Case-Mode 210 is set to zero. Step 1208 is followed by step 1210, where process 1200 ends and the encapsulating logic continues. Process 1200 has the effect of rotating through the potential Case-Mode 210 values of zero, 1 or 2 cyclically. The case mode of zero may be interpreted as a non-shifted text mode. The case mode of 1 may be interpreted as a first character upper case mode. The case mode of 2 may be interpreted as an all upper case mode. Thus the text case of the input-fragment 300 may be set accordingly. When the operator initiates a browse-session 800, Case-Mode 210 will be set to zero unless it is 2 that acts as a caps lock in which Case-Mode 210 is left unchanged. The Rotate-Case process 1200 is generally invoked through activation of the Shift button 110. Those skilled in the art will appreciate that there are numerous ways of implementing the text case management.

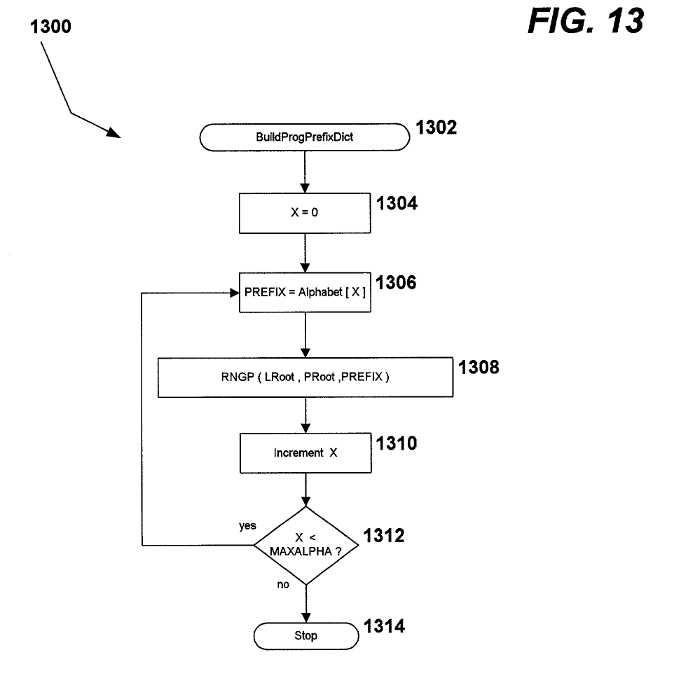

PFPS Generation—FIGS. 13, 14A, 14B, 15

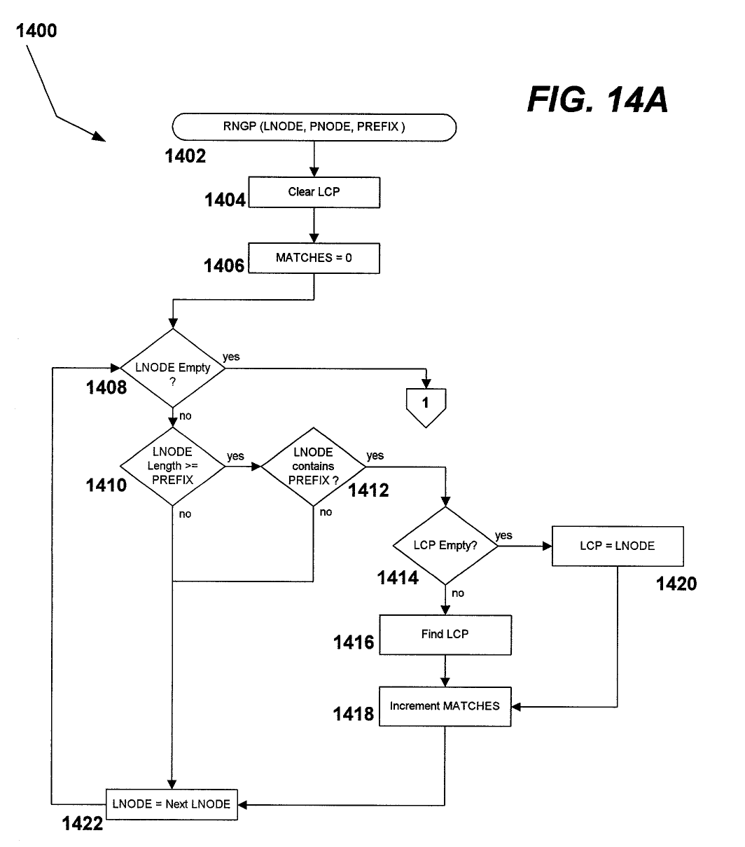

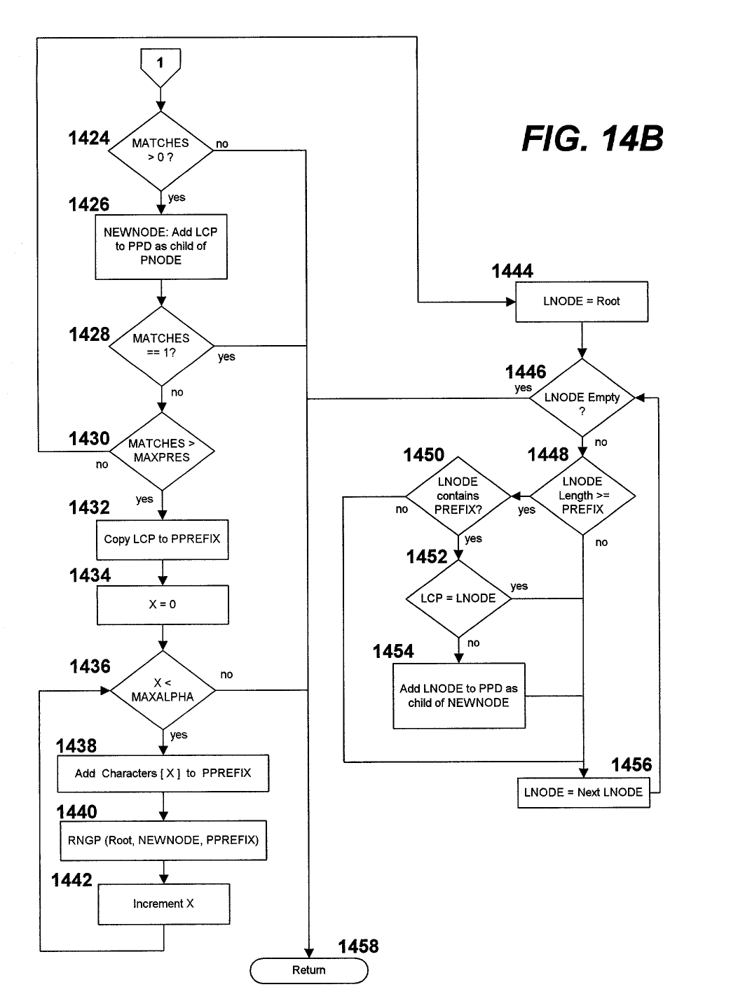

FIG. 13 illustrates a process 1300 to generate properly formed progressive prefix presentation sets, which may be used to create a PPD from an LD. The process 1300 starts at step 1302. Step 1302 is followed by step 1304, where a storage, X, is reset to zero. Step 1304 is followed by step 1306, where a data-string storage, PREFIX, is loaded with the value stored in the X element of the alphabet array 616. Step 1306 is followed by step 1308, where a recursive node generation process (RNGP) 1400 is invoked. RNGP 1400 is passed the LD root-node 606, the PPD root-node 614, and PREFIX. See FIGS. 14A-14B below for a detailed description of the RNGP 1400. Step 1308 is followed by step 1310, where the storage X is incremented by one. Step 1310 is followed by step 1312, where if the storage X is less than MAXALPHA, the “yes” branch is taken, looping back to step 1306. If the storage X is not less than MAXALPHA, the “no” branch is taken to step 1314, where process 1300 ends.

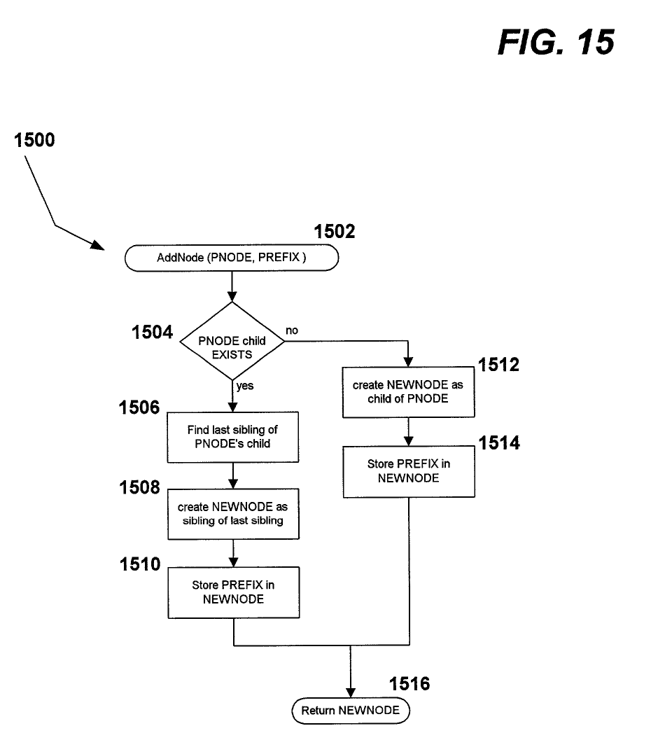

FIGS. 14A-14B illustrates the recursive node generation process (RNGP) 1400. The process 1400 begins at step 1402, accepting an LD node, LNODE, a PPD node, PNODE, and a prefix-fragment, PREFIX. Step 1402 is followed by step 1404, where a storage, LCP, maintaining the Longest Common Prefix-fragment is cleared. Step 1404 is followed by step 1406, where a storage, MATCHES, is set to zero. MATCHES, counts the number of dictionary members in the PPC for PREFIX. Both MATCHES and PREFIX should be local to the iteration instance of the process. Step 1406 is followed by step 1408, where if LNODE is not null the “no” branch is taken to step 1410. In step 1410 if the string associated with LNODE is shorter than PREFIX the “no” branch is taken to step 1422, where LNODE is loaded with the link to its sibling node. Step 1422 loops back to step 1408. Referring back to step 1410, if the string associated with LNODE is at least as long as PREFIX the “yes” branch is taken to step 1412. In step 1412 if PREFIX represents a prefix-fragment for the string associated with LNODE the “yes” branch is taken to step 1414. In step 1414, if LCP is currently empty the “yes” branch is taken to step 1420. In step 1420, LCP is loaded with the string associated with LNODE. Step 1420 is followed by step 1418, where MATCHES is incremented by one. Step 1418 is followed by step 1422, where LNODE is loaded with the link to its sibling node. Step 1422 loops back to step 1408. Referring back to step 1414, if the LCP is currently not empty the “no” branch is taken to step 1416. In step 1416 the LCP is replaced with the longest prefix-fragment common to LCP and the string associated with LNODE. Step 1416 is followed by step 1418, where MATCHES is incremented by one. Step 1418 is followed by step 1422, where LNODE is loaded with the link to its sibling node. Step 1422 loops back to step 1408. Referring back to step 1412, if PREFIX does not represent a prefix-fragment for the string associated with LNODE the “no” branch is taken to step 1422. In step 1422, LNODE is loaded with the link to its sibling node. Step 1422 loops back to step 1408. In step 1408 if LNODE is null the “yes” branch is taken to step 1424 in FIG. 14B. At this point it should be noted that MATCHES represents the size of the PPC for the prefix-fragment in PREFIX. In step 1424, if MATCHES is zero the “no” branch is taken to step 1458, where the process 1400 returns. In step 1424, if the number of prefix matches, MATCHES, is not zero the “yes” branch is taken to step 1426, where a new node NEWNODE is added to the PPD. The string in LCP is assigned to NEWNODE, and NEWNODE is created as a child of PNODE using process 1500 as described below for FIG. 15. Step 1426 is followed by step 1428, where if MATCHES is 1 the “yes” branch is taken to step 1458, where the process 1400 returns. In step 1428 if MATCHES is not 1 the “no” branch is taken to step 1430. Step 1430 acts to limit the size of the PFPS for the given prefix by subdividing the PPC if the size of MATCHES exceeds a maximum presentation size MAXPRES defined by the implementer. The value of MAXPRES is chosen based on the display limitations of the browser-window 102. In step 1430 if the value of MATCHES is greater than MAXPRES the “yes” branch is taken to step 1432. This branch path causes recursive invocation of process 1400 to subdivide the PPC based on the value of the current LCP. This subdivision is accomplished using the same heuristic as that used in process 1300. Those skilled in the art will appreciate that this represents only one heuristic of many that may be used to subdivide the PPC. In step 1432 the string in LCP is copied to a new storage, PPREFIX. Step 1432 is followed by step 1434, where a storage, X, is reset to zero. Step 1434 is followed by step 1436, where if the storage X is not less than MAXALPHA, the “no” branch is taken to step 1458, where the process 1400 returns. At step 1436, if the storage X is less than MAXALPHA, the “yes” branch is taken to step 1438, where the value stored in the X element of the alphabet 616 is concatenated to LCP in PPREFIX. Step 1438 is followed by 1440, where process 1400 is invoked recursively. Process 1400 is passed the location of the LD root-node 606, NEWNODE in the PPD and PPREFIX. Step 1440 is followed by step 1442, where storage X is incremented by one. Step 1442 loops back to step 1436. Referring back to step 1430, if MATCHES is not greater than MAXPRES, the “no” branch is taken to step 1444. This branch enumerates the LD again and adds the matching dictionary nodes to the PPD. In step 1444 LNODE is loaded with the LD root-node 606. Step 1444 is followed by step 1446, where if LNODE is not null the “no” branch is taken to step 1448. In step 1448 if the string associated with LNODE is shorter than PREFIX the “no” branch is taken to step 1456. In step 1456 LNODE is loaded with the next sibling of LNODE. Step 1456 loops back to step 1446. Referring back to step 1448, if the string associated with LNODE is not shorter than PREFIX the “yes” branch is taken to step 1450. In step 1450, if PREFIX is not a prefix-fragment to the string associated with LNODE, the “no” branch is taken to step 1456. In step 1456 LNODE is loaded with the next sibling of LNODE. Step 1456 loops back to step 1446. Referring back to step 1450, if PREFIX represents a prefix-fragment to the string associated with LNODE the “yes” branch is taken to step 1452. Step 1452 is intended to eliminate duplicate entries in the PPD. In step 1452, if the LCP is the same as the string associated with LNODE the “yes” branch is taken to step 1456. In step 1456 LNODE is loaded with the next sibling of LNODE. Step 1456 loops back to step 1446. Referring back to step 1452, if the LCP is not the same as the string associated with LNODE the “no” branch is taken to step 1454. In step 1454, process 1500 is used to add LNODE to the PPD as a child node of NEWNODE. Step 1454 is followed by step 1456, where LNODE is loaded with the next sibling of LNODE. Step 1456 loops back to step 1446. In Step 1446 if LNODE is null the “yes” branch is taken to step 1458, where the process 1400 returns.

FIG. 15 illustrates an add node process 1500 that may be used to add nodes to a progressive prefix dictionary (PPD). The process begins at step 1502 where it receives a pointer to a parent node, PNODE, and a prefix-fragment, PREFIX. Step 1502 is followed by step 1504, where if PNODE has no child node the “no” branch is taken to step 1512. In step 1512 a new node, NEWNODE, is create in the PPD as a child of PNODE. Step 1512 is followed by step 1514, where the PREFIX string is stored in the NEWNODE. Step 1514 is followed by step 1516, where the process 1500 returns NEWNODE. Referring back to step 1504, if a child node exists for PNODE then the “yes” branch is taken to step 1506. In step 1506 the last sibling node of PNODE's child is located. Step 1506 is followed by step 1508, where a new node, NEWNODE, is created as a sibling of the node located in step 1506. Step 1508 is followed by step 1510, where PREFIX string is stored in NEWNODE. Step 1510 is followed by step 1516, where the process 1500 returns NEWNODE.

Presentation Set Extraction—FIGS. 16, 17, 18, 19

FIG. 16 illustrates a process 1600 that may be used to extract presentation sets for the PPIM 100. The process 1600 begins at step 1602, where it accepts a prefix-fragment, PREFIX. Step 1602 is followed by step 1604, where if the current display mode (DM) 208 is PPM the “yes” branch is taken to step 1612. In step 1612, a PFPS extraction process 1700 is invoked to extract a PFPS 718, passing PREFIX and the PPD root-node 614. Step 1612 is followed by step 1614 where the process 1600 returns the presentation set extracted in step 1612. Referring back to step 1604, if the DM 208 is not PPM the “no” branch is taken to step 1606. In step 1606, if a high frequency table page 704 exists for PREFIX, the “yes” branch is taken to step 1608. In step 1608, a HFPS extraction process 1800 is invoked with the value of PREFIX. Step 1608 is followed by step 1614 where the process 1600 returns the presentation set extracted in step 1608. Referring back to step 1606, if a high frequency table page for PREFIX does not exist, the “no” branch is taken to step 1610. In step 1610, a lexicographic presentation set creation process 1900 is invoked with the value of PREFIX. Step 1610 is followed by step 1614 where the process 1600 returns the presentation set extracted in step 1610.

FIG. 17 illustrates a PFPS extraction process 1700. The process 1700 begins with step 1702, where it receives a pointer to a PPD node, NODE, and a prefix-fragment, PREFIX. Step 1702 is followed by step 1704, where if NODE is not null the “no” branch is taken to step 1706. In step 1706, if PREFIX represents a prefix-fragment to the string associated with NODE the “yes” branch is taken to step 1708. In step 1708, if PREFIX is shorter than the string associated with NODE the “yes” branch is taken to step 1726. In step 1726 the string associated with NODE is added to the PFPS. Step 1726 is followed by step 1722, where NODE is replaced with its sibling node. Step 1722 loops back to step 1704. Referring back to step 1708, if PREFIX is not shorter than the string associated with NODE the “no” branch is taken to step 1710. In step 1710 if the child link in NODE is null the “yes” branch is taken to step 1720. In step 1720 if the presentation set is empty the “yes” branch is taken to step 1724. Step 1724 invokes process 1700 recursively passing NODE's child link and PREFIX. Step 1724 is followed by step 1722 where NODE is replaced by NODE's sibling. Step 1722 loops back to step 1704. Referring back to step 1720, if the presentation set is not empty the “no” branch is taken to step 1722. In step 1722 NODE is replaced by NODE's sibling. Step 1722 loops back to step 1704. Referring back to step 1710, if NODE's child is not null the “no” branch is taken to step 1712. In step 1712 NODE is replaced with NODE's child. Step 1712 is followed by step 1714, where if NODE is null the “yes” branch is taken to step 1722 where NODE is replaced by NODE's sibling. Step 1722 loops back to step 1704. Referring back to step 1714, if NODE is not null the “no” branch is taken to step 1716, where NODE is added to the PFPS. Step 1716 is followed by step 1718, where NODE's sibling replaces NODE. Step 1718 loops back to step 1714. Referring back to step 1706, if NODE does not contain PREFIX as a prefix-fragment the “no” branch is taken to step 1720. In step 1720 if the presentation set is empty the “yes” branch is taken to step 1724. Step 1724 invokes process 1700 recursively passing NODE's child link and PREFIX. Step 1724 is followed by step 1722 where NODE is replaced by NODE's sibling. Step 1722 loops back to step 1704. Referring back to step 1720, if the presentation set is not empty the “no” branch is taken to step 1722. In step 1722 NODE is replaced by NODE's sibling. Step 1722 loops back to step 1704. At step 1704 if NODE is null the “yes” branch is taken to step 1728, where the PFPS is returned.

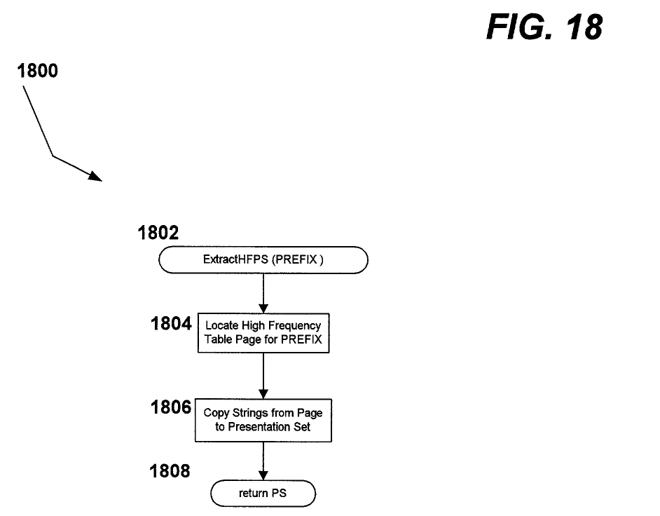

FIG. 18 illustrates a process 1800 that may be used to extract an HFPS. The process starts at step 1802, where it receives a prefix-fragment, PREFIX. Step 1802 is followed by step 1804, where a high frequency table page is located for PREFIX. Step 1804 is followed by step 1806, where the strings in the found page are copied to the presentation set. Step 1806 is followed by step 1808, where the presentation set is returned.

FIG. 19 illustrates a process 1900 that may be used to extract a lexicographic presentation set. The process 1900 starts at step 1902, where it receives a prefix-fragment, PREFIX. Step 1902 is followed by step 1904, where a storage PNODE is loaded with the pointer to the PPD root-node 614. Step 1904 is followed by step 1906, where if PNODE is null the “yes” branch is taken to step 1916, where the presentation set 710 is returned. At step 1906, if PNODE is not null the “no” branch is taken to step 1908. At step 1908 if PREFIX does not represent a prefix-fragment for the string associated with PNODE the “no” branch is taken to step 1914. In 1914, PNODE is loaded with its sibling link. Step 1914 loops back to 1906. Referring back to step 1908, if PREFIX represents a prefix-fragment for the string associated with PNODE the “yes” branch is taken to step 1910. In step 1910 if the presentation set column associated with the length of PNODE's string is full, the “yes” branch is taken to step 1914. In step 1914, PNODE is loaded with its sibling link. Step 1914 loops back to 1906. Referring back to step 1910, if the presentation set column associated with the length of PNODE's string is not full, the “no” branch is taken to step 1912. In step 1912 the string associated with PNODE is added to the presentation set in the free array element associated with its length. Step 1912 is followed by step 1914, where PNODE is loaded with its sibling link. Step 1914 loops back to 1906.

Advantages

The advantages attained by a PPIM are manifold. The successive approximation nature of a PPIM is both simple and intuitive. A PPIM provides multiple pathways to a desired data-string and a hybrid PPIM provides more pathways to the desired data-string than is possible using either a PPIM alone or an auxiliary input method alone. More paths to a desired data-string increase the probability of the operator finding a short, intuitive path to the desired input. Multiple paths thus provide a greater flow for the input operation with accompanying ease of composition. The browsing paradigm further provides the advantage of being able to make corrections at a much higher rate than a standard input environment. This paradigm also provides the operator the ability to browse for unknown spellings or alternate words in a directed manner. A PPIM is also highly adaptable, potentially being used alone or in a hybrid implementation. A PPIM also has the ability to be used as a generalized input method or customized for use for specific applications.

Operation of the Preferred Embodiment—FIGS. 1A-1D, 2, 3, 4, 5, 6, 7, 8

The preferred embodiment of the invention is a hybrid input method. The hybrid is composed of a PPIM 100, an auxiliary input method 122 and an add-on list based acceleration method. The PPIM 100 incorporates a PPD with an associated alphabet along with PFPS and HFPS extraction processes. The PPD may be employed for performance reasons, however should the implementation allow, presentation sets may be generated in real-time from an LD. The PPD for this embodiment is structured with English words and phrases or prefix-fragments thereof. This choice of English is made for simplification of the discussion and should not be taken as a limitation of a PPIM. The embodiment uses a browsing paradigm similar to a web browser, providing the operator the ability to browse to desired input strings held in the PPD or enter unique entries using the auxiliary input method 122. The preferred embodiment as depicted in FIGS. 1A-1D, shows a PPIM browsing environment 100 on a portable computer 118. The operator may interact with the active-application of the portable computer 118 through the touch sensitive screen 120. The PPIM continuously monitors the operators' input coming from the auxiliary input method (AIM) 122. When a character from the alphabet is detected a browse-session 800 is initiated. When a new session 800 is initiated the operators' input is stored in the input-fragment 300 and a command-bar 104 is displayed with command buttons 108-116 and the display 106. The display 106 reflects the contents of the input-fragment 300. The DM is reset to HFM, and substantially simultaneously a presentation set is generated and displayed in the browse-window 102 adjacent to the command-bar 104. When a browse-session 800 terminates the browse-window 102 and command-bar 104 are removed from the display to permit viewing the active-application beneath. During the session 800 the operator has the options of selecting an entry from the browse-window 102, entering another character through the AIM 122, or entering a command. The operator makes a selection form the browse-window 102 by tapping the touch sensitive screen on the entry desired. If a selection is made from the browse-window 102 the input-fragment 300 is replaced with the selection. If a character is entered from the AIM 122, the entry is concatenated to the input-fragment 300. In either case the input-fragment 300 is updated and sent to the input-display 106 and the DM is updated. The DM is updated based on the length of the input-fragment 300. When the input-fragment 300 exceeds two characters the mode is changed from HFM to PPM. After input-fragment 300 is updated a new presentation-set is generated and displayed in the browse-window 102 and the process repeats. Commands may be of two types, acceptance commands and control commands. Acceptance commands cause the termination of the browse-session 800, with subsequent forwarding of the input-fragment 300 to the active-application. Acceptance commands are initiated in three ways. The operator may use a gesture during selection from the browse-window 102. The operator may also enter punctuation from the AIM 122. In either case the punctuation associated with the AIM 122 input or the gesture is concatenated to the input-fragment 300 prior to session 800 termination. Alternately any non-alphabet input from the AIM 122 may cause an acceptance command. This non-alphabet input is implementation specific and may include such things as key combinations from the AIM 122 that cause the active-application to change etc. Control commands cause the operating environment of the PPIM 100 to be changed. Control commands are initiated by actuating the command buttons 108-116. The browse-back button 112 restores the input-fragment 300 and presentation set prior to the current state. Browse-back commands may occur at any time during the session 800. The backspace button 114 causes the last character from the input-fragment 300 to be truncated and the updated input-fragment 300 to be displayed 106. Following truncation a new presentation set is generated and displayed 102. If the Mode button 108 is actuated the DM is changed from HFM to PPM or vice versa and a new presentation set is generated and displayed 102. Each actuation of the Shift button 110 rotates Case-Mode 710, and subsequently changes the input-fragment 300 between three different states as well as updating the display 106. The initial state is non-capitalized, where the input-fragment 300 has no capitalization. The next state is leading capitalization where the first character of the input-fragment 300 is capitalized. The next state is all capitalized. When a new browse-session 800 is initiated, the Case-Mode 710 is reset to non-capitalized unless it is already in the all capitalized state. The all capitalized state is thus treated as a shift lock. The Cancel button 116 causes the browse-session 800 to be abandoned along with the input-fragment 300 and subsequently the browse-window 102 and command-bar 104 are removed from the display 120.

History Management—FIG. 2

A history 200 is maintained for the browse-session 800 from initiation through termination. The history 200 includes the input-fragment history IFHistory 202 and the mode history ModeHistory 204. These are implemented as arrays of prefix-fragments for the IFHistory array 202 and display modes for the DM array 204. A pointer HistoryPtr 206 is used to locate the first empty entry in the IFHistory 202 and DM 204 arrays. On session 800 initiation, the history 200 and HistoryPtr 206 are cleared. The initial input-fragment 300 and DM 208 are then loaded into the arrays and HistoryPtr 206 is incremented.

Generating a PPD—FIGS. 13, 14A, 14B, 15

The preferred embodiment utilizes a PPD formed from an LD. For some implementations, PFPS generation may be done in real-time from an LD. However in applications with an extensive LD, real-time generation may not be practical, also there may not be an adequate heuristic to produce PFPS from the dictionary in a reliable fashion. Also the computational limitations of the implementation may preclude real-time PFPS generation. Therefore it may be desirable to preprocess the dictionary into PPD form. In the preferred embodiment, a Longest Common Prefix (LCP) heuristic is used to generate the PPD. The heuristic limits the size of a PFPS to the size of the alphabet. It also acts to reduce the PFPS size below an implementer defined maximum size, MAXPRES, to accommodate the display space. Depending upon the specifics of the implementation it may be necessary to perform further subdivision to ensure that presentation sets do not exceed the presentation space. The logic depicted in FIG. 13, has the effect of looping in steps 1306-1312, to subdivide the root set of the dictionary. This logic will find the LCP for all the prefix-fragments in the LD that start with each character in the alphabet. FIG. 14A represents the entry point for the recursive part of the PPD generation process. The loop in steps 1408-1422 searches the LD to enumerate the PPC for PREFIX, which was passed to the process. Within this loop, steps 1414-1420 determine the LCP for the enumerated PPC. Once the enumeration is complete control passes to FIG. 14B, where if no matches are found the process returns to the caller. Otherwise the LCP is added to the PPD as a child node of PNODE, which was passed to the process. If there is only one match, the process returns, with the LCP having been added to the PPD. Otherwise a test is made to determine if the enumerated matches exceed the maximum size, MAXPRES, desired for a presentation set. If it exceeds MAXPRES, the PPC is then subdivided. Subdivision of the PPC is accomplished by adding each character from the alphabet to the end of the LCP and recursively invoking process 1400 to find the LCP for the combination, as shown in steps 1432-1442. If at step 1430 the enumerated count is within the allowed maximum, the dictionary is enumerated for PREFIX again in steps 1444-1456 and, as found, the prefix-fragments are added to the PPD as children of NEWNODE created at step 1426. When adding nodes to the PPD they are added by process 1500, where a new node is always added as the last sibling-node of the child-node of the parent-node, which is passed to process 1500. Note that the same heuristic could be used to generate real-time PFPS under the appropriate conditions. Although linked lists have been used for expositional purposes to represent the LD and PPD, those skilled in the art will appreciate that a variety of data structures may have been used and that a wide variety of heuristics may be employed to subdivide a PPD.

Generating a Presentation Set—FIGS. 16, 17, 18, 19

Presentation sets are extracted by process 1600, providing the operator a collection of prefix-fragments in the browse-window 102 from which they may select. The presentation sets may be either HFPS or PFPS, depending upon the state of DM 208. The Mode-Update process 1100 is invoked whenever the input-fragment 300 changes in order to reflect the DM 208 that should be used by process 1600. When the input-fragment 300 is shorter than 3 characters, process 1100 sets DM 208 to HFM otherwise PPM is used. The preferred embodiment assumes existence of high frequency table pages for all prefix-fragments with length less than 3 characters. HFM may be selected by a control command when the input-fragment exceeds 2 characters. Step 1604 tests for HFM or PPM and branches to the appropriate presentation set extraction process. When HFM is selected and the input-fragment 300 is less than 3 characters in length the prefix-fragment is used as a pointer to a HFT page. The pointers on the HFT page are then used to extract the HFPS 710. When HFM is selected and the input-fragment 300 is longer than 3 characters in length the PPD is searched lexicographically for matches for the input-fragment 300. When in PPM, presentation sets are extracted by process 1700. Process 1700 has the effect of filling the presentation set 718 with the child-node and siblings of the child-node for the node that matches the prefix-fragment. A special case occurs where a prefix-fragment does not match any of the PPD members exactly. In this case the PFPS is generated using all the siblings of the first node that contains the prefix-fragment and the first node itself.

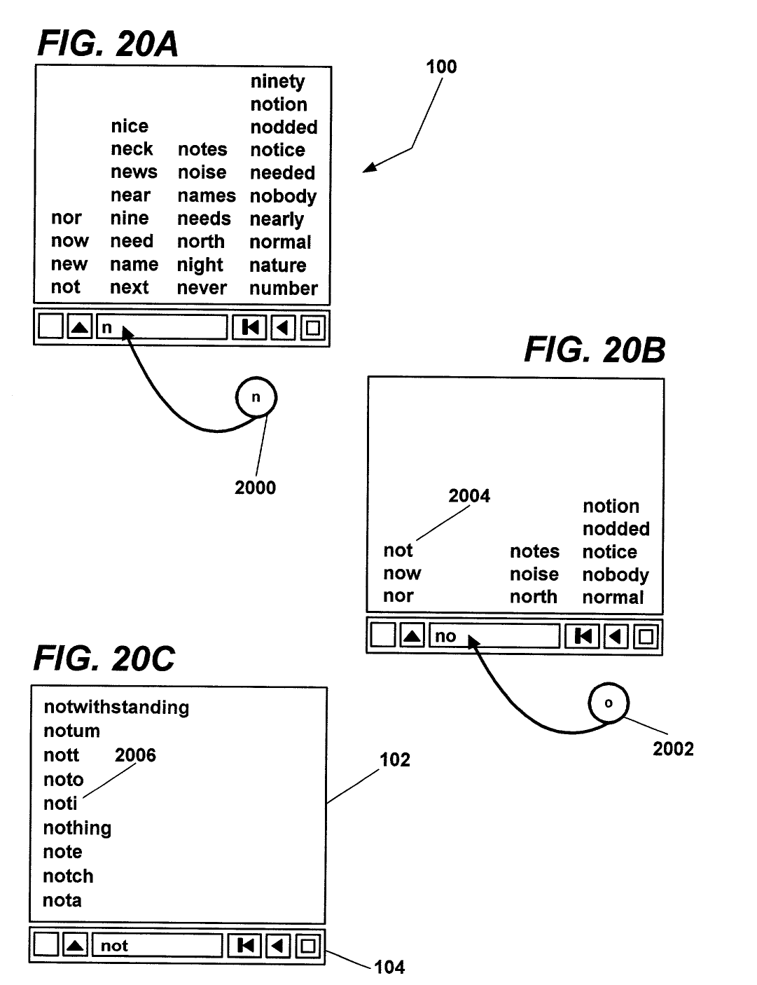

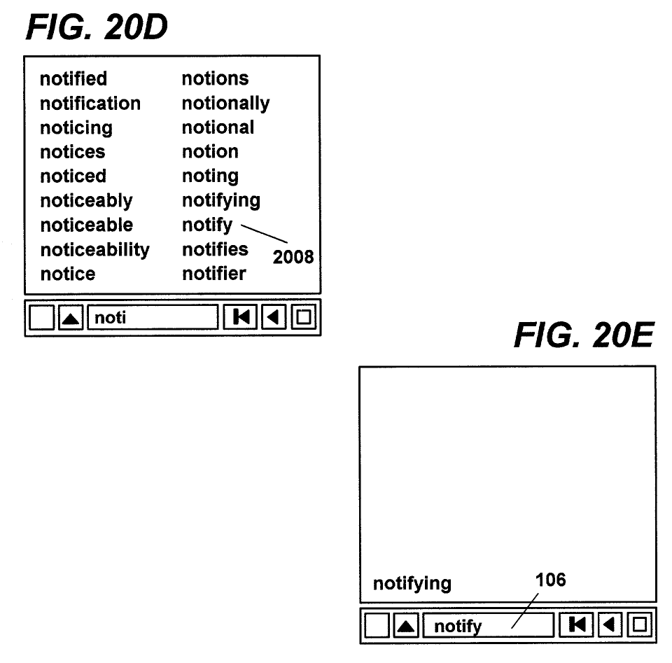

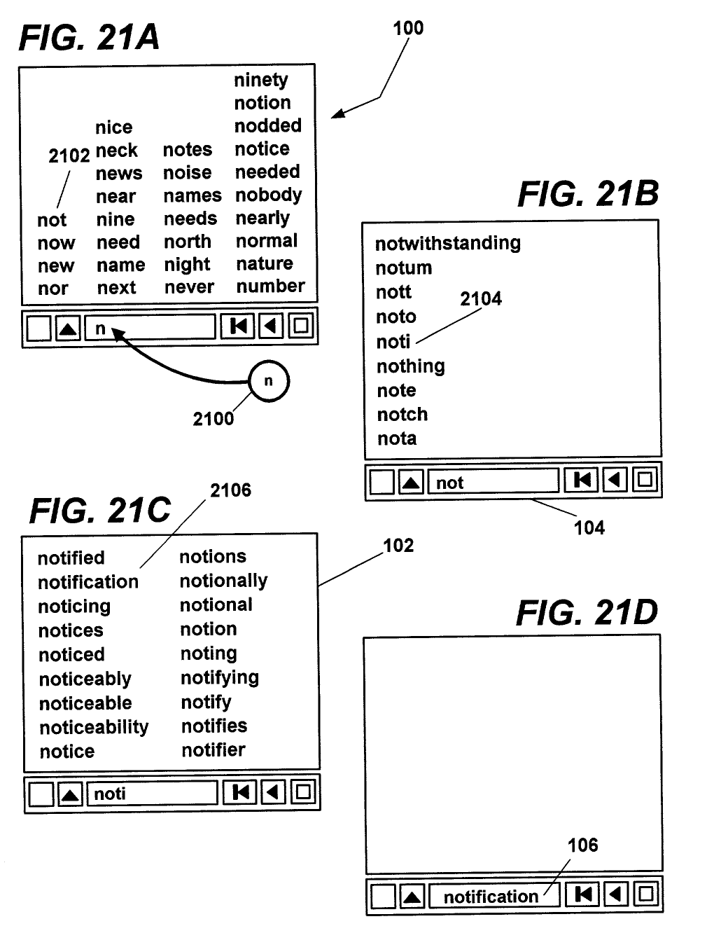

Example Browse Sequences—FIGS. 20A-20E, 21A-21D

Following are two exemplary browse sequences for the preferred embodiment. Those skilled in the art will recognize that these examples do not reflect all the potential pathways to the end goals stated. PPIMs by design have a large number of pathways to any given data-string.

FIGS. 20A-20E illustrate an exemplary browse sequence to enter a desired string, “notify”, using the preferred embodiment. A browse-session 800 is initiated when the auxiliary input method 122 delivers a character “n” 2000 to the PPIM 100. FIG. 20A depicts the PPIM 100 rendering of a HFPS 710 for the prefix-fragment “n”. The browse-window 102 displays 4 columns individually ordered by frequency. Columns from left to right have word lengths of 3, 4, 5 and 6 respectively and represent the entries in a high frequency table page 704 for the prefix-fragment “n”. In FIG. 20B the operator enters the character “o” 2002 through the AIM 122. The entry is concatenated to the current input-fragment 300 resulting in “no”. FIG. 20B depicts the rendering of a HFPS 710 for the input-fragment “no”. The operator then may select the closest string to “notify” by tapping “not” 2004 on the display 102. FIG. 20C depicts the PPIM 100 displaying a PFPS 718 for the prefix-fragment “not”. In FIG. 20C the closest entry to “notify” is the prefix-fragment “noti” 2006, which the operator may select by tapping that entry on the display 102. FIG. 20D depicts the PPIM 100 displaying a PFPS 718 for the prefix-fragment “noti”. In FIG. 20D “notify” is in the presentation set. At this point the operator may select “notify” 2008 by tapping on the display 102. Alternately the operator may use a gesture when selecting “notify” 2008, thus entering an acceptance command along with punctuation associated with the gesture and terminating the browse-session 800. Should the operator use a tap selection only, the browse-session 800 would continue to FIG. 20E. In FIG. 20E a PFPS 718 for the prefix-fragment “notify” is rendered. At this point the operator may issue an acceptance command by tapping display 106 or a by using a gesture on the display 106 to terminate the browse-session 800. An acceptance command may also result from punctuation from the AIM 122.

FIG. 21 illustrates an exemplary browse sequence to enter a desired string, “notification”, using the preferred embodiment. The browse-session 800 is initiated when the auxiliary input method 122 delivers a character “n” 2100 to the PPIM 100. FIG. 21A depicts a browsing environment 100 displaying a high frequency presentation set for the prefix-fragment “n”. The browse-window 102 displays 4 columns individually ordered by frequency. Columns from left to right have word lengths of 3, 4, 5 and 6 respectively and represent the entries in a high frequency table page for the prefix-fragment “n”. The closest prefix-fragment to the desired input is “not” 2102, which the operator may select by tapping that entry on the browse-window 102. FIG. 21B depicts the environment 100 displaying a PFPS for the prefix-fragment “not”. In FIG. 21B the closest entry to “notify” is the prefix-fragment “noti” 2104, which the operator may select by tapping “noti” 2104 on the browse-window 102. FIG. 21C depicts the environment 100 displaying a PFPS for the prefix-fragment “noti”. In FIG. 21C “notification” 2106 is in the presentation set. At this point the operator may continue by tapping “notification” 2106 on the display panel. Alternately the operator may use a gesture when selecting “notification” 2106 thus entering an acceptance command along with punctuation associated with the gesture and terminating the session 800. Should the operator use a selection only, the browse-session 800 would continue to FIG. 21D. In FIG. 21D a PFPS for the prefix-fragment “notification” is displayed and the PFPS in this case is empty. The operator may then issue an acceptance command by tapping or by using a gesture on the display 106 to terminate the browse-session 800. An acceptance command may also result from punctuation from the AIM 122.

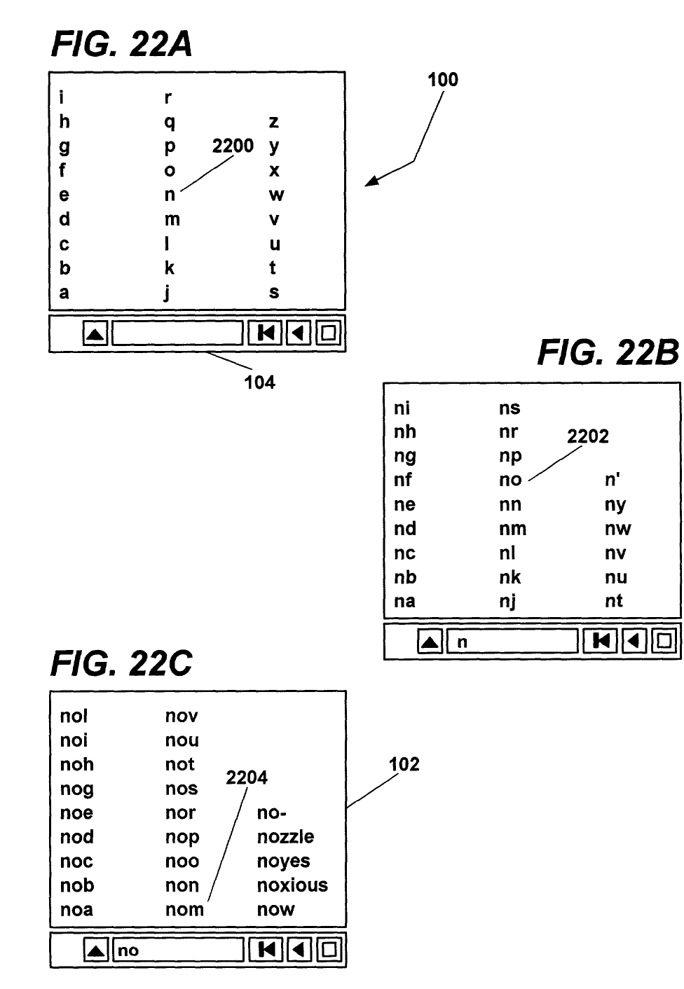

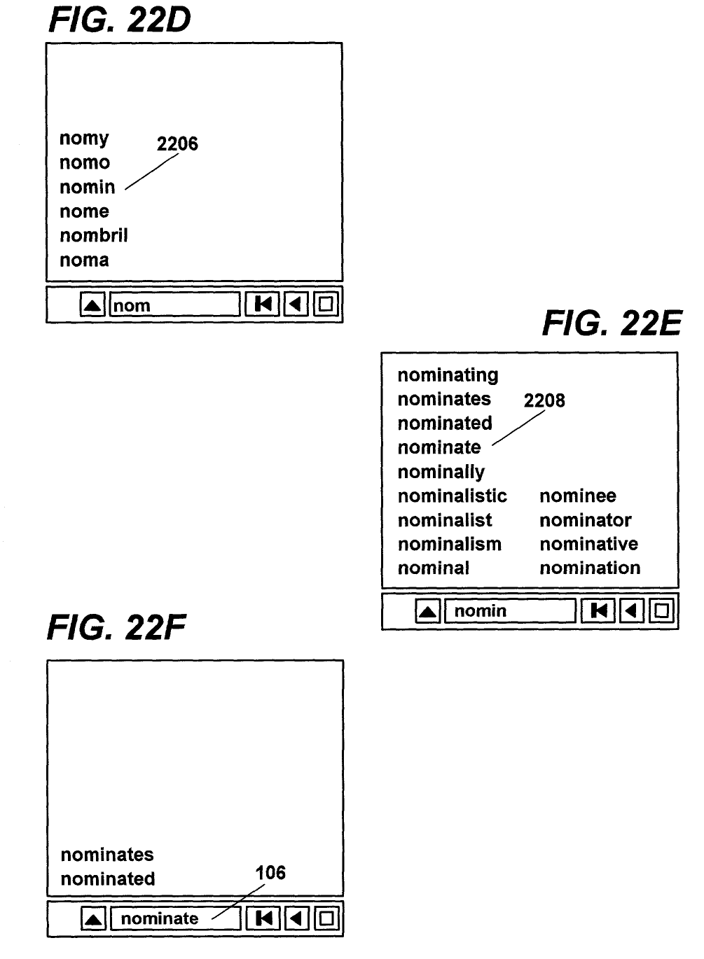

Detailed Description—Stand-Alone Embodiment—FIGS. 22A-22F

In implementations that have sufficient display area, continuous display of the browsing environment permits a stand-alone PPIM implementation. Following is an exemplary browse sequence for a stand-alone PPIM. In this mode of operation a PPIM always starts a new browse-session 800 displaying a root set PFPS. This mode does not employ auxiliary acceleration or input methods so sequential selection form PFPS provides comprehensive access to the contents of the dictionary contents only. The logic used in this implementation may be identical to the browse-session 800, with the elimination of DM 208 support and providing only operator input from the browse-window 102. An identical dictionary to that used in the preferred embodiment may be employed if desired.

FIGS. 22A-22F illustrates a browse sequence to enter a desired string, “nominate”, utilizing a stand alone PPIM 100. The scenario associated with this browse sequence is one in which there is no auxiliary input method or acceleration technology. The browse environment in FIG. 22A depicts a browse-window 102 displaying a root-set PFPS and the command-window 104 displaying the null prefix-fragment (NPF). This root-set represents the progressive prefix subdivision of the GPPC. As is the case at each stage, it is the operator's goal to select the prefix-fragment that most closely represents the desired target string. The operator may select an element of the PFPS 718 by tapping the given display element. In FIG. 22A the operator would tap the “n” element 2200. FIG. 22B depicts the subsequent browser representation of the PFPS 718 for the “n” prefix-fragment. In this case the operator would tap the “no” item 2202. FIG. 22C depicts the subsequent browser representation of the PFPS 718 for the “no” prefix-fragment. In this case the operator would tap the “nom” item 2204. FIG. 22D depicts the subsequent browser representation of the PFPS 718 for the “nom” prefix-fragment. In this case the operator would tap the “nomin” item 2206. FIG. 22E depicts the subsequent browser representation of the PFPS 718 for the “nomin” prefix-fragment. In this case the operator could tap the “nominate” item 2208. FIG. 22F depicts the subsequent browser representation of the PFPS 718 for the “nominate” 2208 prefix-fragment. In this case the operator would enter an acceptance command by tapping the display 106 or using a gesture in the display 106 to produce an acceptance command along with concatenating to the input-fragment 300 the punctuation associated with the gesture. Referring back to FIG. 22E, the operator may alternately use a gesture to accept the “nominate” item from the browse-window 102, thus concatenating to the input-fragment 300 the punctuation associated with the gesture and terminating the browse-session 800. An acceptance command may also result from punctuation from the AIM 122.

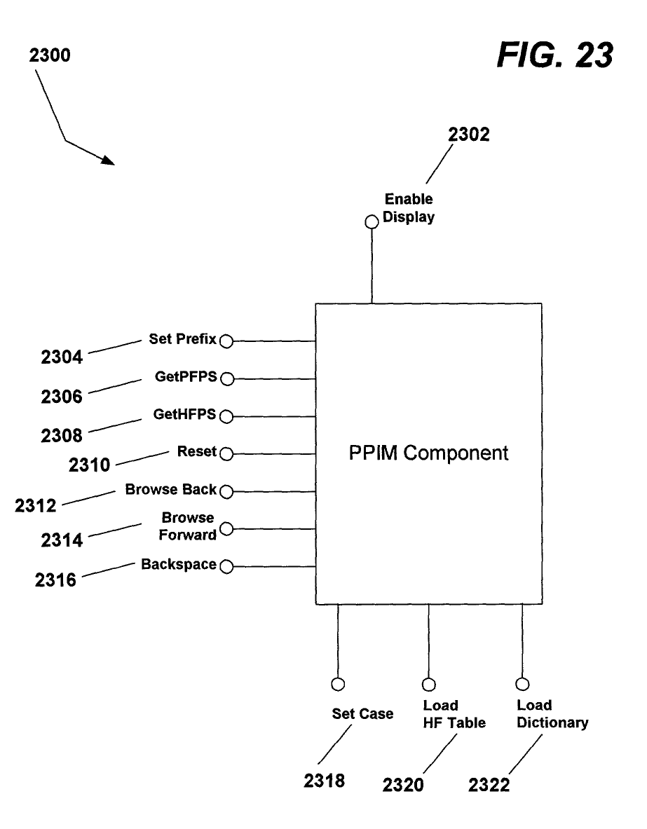

Detailed Description—PPIM Component Embodiment—FIG. 23

FIG. 23 depicts a PPIM component embodiment 2300 of a PPIM. In this embodiment an application may customize all aspects of the operation of the component 2300. The basics of PFPS generation remains unchanged from a hybrid or a stand-alone PPIM, but interfaces are provided to allow the application to control the operation of the component 2300. An interface 2302 is provided to permit the application to override the display of the PPIM browse environment 100. Interface 2320 is available to set the high frequency table 700 used by the component 2300. Interface 2322 allows the application to set the dictionary to a custom implementation. Operation of the component 2300 is provided through a set of 8 interfaces. Interface 2304 sets the input-fragment 300 used by the component 2300. Interface 2306 causes the component 2300 to generate a PFPS 718 for the input-fragment 300 set previously through interface 2304. Interface 2308 causes the component 2300 to generate a HFPS 710 for the input-fragment 300 set previously through interface 2304. Interface 2310 resets the component 2300 history 200. Interface 2312 causes the component 2300 to execute the browse-back process 1000. Interface 2314 causes the component 2300 to execute a browse-forward process, which is an analogue to the browse-back process 1000. Interface 2316 causes the component 2300 to execute the backspace process 900. Interface 2318 causes the component 2300 to execute the rotate-case process 1200.

### CONCLUSIONS, RAMIFICATIONS AND SCOPE

Accordingly, the reader will appreciate that a PPIM reduces the mechanical requirements of data entry. Through the extended selection area of prefix-fragments in a presentation-set a PPIM reduces the accuracy required on the part of the operator. Additionally, the successive approximation nature of a PPIM is completely recognition based and does not require the use of rules or memorization to be employed effectively. A PPIM improves on other input methods as acceleration is a byproduct of the operation of a PPIM and does not require ancillary tasks with distracting task switching. Also, the manner with which acceleration is achieved, where the input-fragment may grow by more than one character per PFPS selection, results in a greater perception of progress and continuity for the operator. Additionally, composition is aided since the dictionary basis of a PPIM ensures correct spelling, and the browsing capability allows operators to investigate vocabulary effectively. The browsing capabilities make a PPIM error symmetric, where errors may be corrected with the same number of inputs as were used in the incorrect entry. This correction symmetry is not seen in other accelerated input methods. Additionally the versatility of a PPIM is seen in how it may be used alone or as a hybrid. This versatility is also apparent in how a PPIM may be used by an operating system with a general dictionary suitable for all applications, or alternatively individual applications may control the display design and layout as well as the dictionaries employed.

Those skilled in the art will appreciate that although we have discussed application to orthographic languages, the scope of the invention is not limited to them, but is applicable to all variety of data entry involving collections of data that may be organized as PFPS.

Although the description above contains many specifics, these should not be construed as limiting the scope of the invention but as merely providing illustrations of some of the presently preferred embodiments of this invention. Thus the invention may be embodied in many forms without departing from the spirit or essential characteristics of the invention. The present embodiments are therefore to be considered in all respects as illustrative and not restrictive, the scope of the invention being indicated by the appended claims rather than by the foregoing description; and all changes which come within the meaning and range of equivalency of the claims are therefore intended to be embraced therein.

The invention claimed is:

1) A method for data entry on a computer comprising:
a progressive prefix dictionary storage means for storing a plurality of data-strings;
whereby extracting a properly formed progressive prefix presentation set from the dictionary based on selection from a current properly formed progressive prefix presentation set, in a recursive manner, provides comprehensive access to the plurality of data-strings in said progressive prefix dictionary storage means.

2) A method for data entry on a computer comprising:
a dictionary storage means for storing a plurality of data-strings;
a properly formed progressive prefix presentation set generation means;
whereby generating a properly formed progressive prefix presentation set from the dictionary based on selection from a current properly formed progressive prefix presentation set, in a recursive manner, provides comprehensive access to the plurality of data-strings in said dictionary storage means.

3) A method for data entry on a computer comprising:
a dictionary storage means for storing a plurality of prefix-fragments;
a progressive prefix input method means;
an input-fragment storage means;
performing the steps of:
a) continuously monitoring the entry of data into an active application that is running on the computer;
b) clearing the contents of the input-fragment;
c) upon receipt of data, accumulating said data with the input-fragment and;
i) substantially simultaneously generating a properly formed progressive prefix presentation set from the dictionary such that the presentation set is representative of the input-fragment;
ii) substantially simultaneously displaying via said display means said properly formed progressive prefix presentation set along with the input-fragment;
d) while continuously displaying the input-fragment and the presentation set, monitoring for further input data from and;
i) repeating from step (b) if said input data is a selection from the presentation set or;
ii) if said input-data represents an acceptance command, sending the input-fragment to said active application;

4) The method as in claim 3, further including an auxiliary input means wherein step d) includes the step;
iii) repeating from step (c) if said input-data is data from said auxiliary input means;

5) The method as in claim 4, wherein step (c) is as follows;
c) upon receipt of data, accumulating said data with the input-fragment and;
i) when the input-fragment length is less than a given value, does substantially simultaneously generate a high frequency presentation set from the dictionary such that the presentation set is representative of the input-fragment;
ii) when the input-fragment length is not less than said given value, does substantially simultaneously generate a properly formed progressive prefix presentation set from the dictionary such that the presentation set is representative of the input-fragment;
iii) substantially simultaneously displaying via the output means the presentation set along with the input-fragment;

6) The method as in claim 3, further including a history means, wherein said history maintains state information for the progressive prefix input method.

7) The method as in claim 6, further including a browse-back command means, wherein the command causes the progressive prefix input method to revert to the state prior to the current state contained in said history means.

8) The method as in claim 3, further including a shift command means, wherein said shift command will augment the text case of the input-fragment.

9) The method as in claim 3, further including a mode command means, wherein said mode command will cause the progressive prefix input method to switch between displaying high frequency presentation sets, and properly formed progressive prefix presentation sets.

10) The method as in claim 3, further including a backspace command means, wherein said backspace command will truncate the last character from the input-fragment.

11) The method as in claim 3, further including a cancel command means, wherein said cancel command will abandon the input-fragment and terminate said progressive prefix input method.
